(19) United States
(12) Patent Application Publication
(10) Pub. No.: US 2026/0124593 A1
(43) Pub. Date: May 7, 2026

(54) SYSTEMS AND METHODS FOR COMBINATORIAL SYNTHESIS AND SCREENING OF MULTIELEMENT MATERIALS

(71) Applicant: UNIVERSITY OF MARYLAND, COLLEGE PARK, College Park, MD (US)

(72) Inventors: Liangbing HU, Woodbridge, CT (US); Yonggang YAO, College Park, MD (US); Qi DONG, Newton, MA (US)

(21) Appl. No.: 19/429,220

(22) Filed: Dec. 22, 2025

Related U.S. Application Data
(63) Continuation of application No. 17/690,767, filed on Mar. 9, 2022.
(60) Provisional application No. 63/158,645, filed on Mar. 9, 2021.

(51) Int. Cl. B01J 19/00; C40B 30/10

(52) U.S. Cl. CPC B01J 19/0046; C40B 30/10; B01J 2219/0036; B01J 2219/00495; B01J 2219/00716; B01J 2219/00752; B01J 2219/00756

(57) ABSTRACT

Precursors for forming a plurality of multielement materials of different compositions can be deposited on different portions of a common substrate according to a combinatorial approach. The substrate can be subjected to a thermal shock, thereby converting the deposited precursors into separate multielement materials on the substrate. The thermal shock can be a temperature greater than or equal to 500° C. and a duration less than 60 seconds. In some embodiments, each multielement material can be tested with respect to an electrical property, a chemical property, or an optical property. Based on the results of the testing, a composition of a multielement material can be determined for use in a predetermined application, such as use as a catalyst, a plasmonic nanoparticle, an energy storage device, an optoelectronic device, a solid-state electrolyte, or an ion conductive membrane.

### CROSS-REFERENCE TO RELATED APPLICATIONS

The present application is a continuation of U.S. application Ser. No. 17/690,767, filed Mar. 9, 2022, which claims the benefit of U.S. Provisional Application No. 63/158,645, filed Mar. 9, 2021, entitled “Combinatorial Synthesis and High Throughput Screening of Multielement Nanoparticles and Functional Bulk Materials,” each of which is incorporated by reference herein in its entirety.

### FIELD

The present disclosure relates generally to multielement material synthesis, and more particularly, to systems and methods for determination of a composition of multielement material (e.g., nanocluster, nanoparticle, or bulk material) for a particular application via combinatorial synthesis and screening.

### BACKGROUND

Nanoparticles with a range of sizes and morphologies have been studied for various catalytic applications. These nanoparticles are typically comprised of no more than three elements to avoid synthetic complexity and structural heterogeneity. Multielement nanoclusters having three or more elements thus present a vast and largely undiscovered chemical space that can offer synergistic interactions between different elements. Yet, with increasing compositional complexity, conventional fabrication methods can lead to multielement particles with large size distributions and/or inhomogeneous structures (e.g., phase separation and/or elemental segregation within the particles), which may result from the inability of conventional fabrication methods to control the kinetics and dynamics of chemical reactions at the nanoscale among dissimilar constituent elements. As a result, it remains a challenge to tune the composition of fabricated materials in order to systematically study the properties thereof, thus limiting material discovery, property optimization, and mechanistic understanding for different functionalities.

Embodiments of the disclosed subject matter may address one or more of the above-noted problems and disadvantages, among other things.

### SUMMARY

Embodiments of the disclosed subject matter system provide systems and methods for combinatorial synthesis and screening of multielement materials, for example, multielement nanoclusters, nanoparticles, or bulk materials. Multielement nanomaterials hold great promise for various applications due to their widely tunable surface chemistries. Yet it remains challenging to efficiently study this multi-dimensional space because conventional approaches are typically slow and depend on serendipity. Embodiments of the disclosed subject matter can thus address these deficiencies by offering a high-throughput technique for combinatorial compositional design (e.g., formulation in solution phases) and rapid synthesis (e.g., rapid, high-temperature exposure on the order of seconds) of multielement (e.g., multimetallic) materials (e.g., nanoparticles, nanoclusters, and/or bulk materials) with a homogeneous structure. The materials with different compositions can be subject to rapid screening, for example, to discover optimal and/or synergistic compositions for particular applications, such as but not limited to use as a catalyst, a plasmonic nanoparticle, an energy storage device, an optoelectronic device, a solid-state electrolyte, an ion conductive membrane, a fluorescent material, a component thereof, or any combination of the foregoing.

In one or more embodiments, a method can comprise depositing one or more first precursors on a first portion of a substrate and depositing one or more second precursors on a second portion of the substrate. The second portion can be spaced from the first portion. The method can further comprise subjecting each of the first and second portions of the substrate to a first temperature for a first time period so as to convert the deposited one or more first precursors into a first material and to convert the deposited one or more second precursors into a second material. The first material can have a different composition than the second material. The first temperature can be greater than or equal to about 500° C., and a duration of the first time period can be less than about 60 seconds. In some embodiments, the method can further comprise testing each of the first and second materials with respect to an electrical property, a chemical property, an optical property, or any combination thereof. In some embodiments, the method can also comprise determining a composition of a material for use in a predetermined application based at least in part on results of the testing.

In one or more embodiments, a system can comprise a dispensing device, a heating device, and a control system. The dispensing device can have a nozzle facing a surface of a substrate and constructed to deposit precursors onto the substrate. At least one of the nozzle and the substrate can be movable with respect to the other. The heating device can be constructed to generate a first temperature of at least 500° C. The control system can be operatively coupled to the dispensing device and the heating device. The control system can comprise one or more processors and computer readable storage media. The computer readable storage media can store instructions that, when executed by the one or more processors, cause the control system to (i) control the dispensing device to position the nozzle with respect to a first portion of the substrate, (ii) deposit, via the nozzle, one or more first precursors on the first portion, (iii) control the dispensing device to position the nozzle with respect to a second portion of the substrate, the second portion being spaced from the first portion, (iv) deposit, via the nozzle, one or more second precursors on the second portion, and (v) subject, via the heating device, each of the first and second portions of the substrate to the first temperature for a first time period so to convert the deposited one or more first precursors into a first material and to convert the deposited one or more second precursors into a second material. The first material can have a different composition than the second material, and a duration of the first time period can be less than 60 seconds.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a simplified schematic diagram illustrating aspects of an exemplary synthesis system, according to one or more embodiments of the disclosed subject matter.

FIG. 1B is a simplified schematic diagram illustrating aspects of exemplary synthesis and screening systems, according to one or more embodiments of the disclosed subject matter.

FIG. 2A is a simplified schematic diagram illustrating operation of an exemplary dispensing device to sequentially deposit precursors, according to one or more embodiments of the disclosed subject matter.

FIG. 2B is a simplified schematic diagram illustrating operation of another exemplary dispensing device to deposit pre-mixed samples, according to one or more embodiments of the disclosed subject matter.

FIG. 2C is a simplified schematic diagram illustrating operation of another exemplary dispensing device to mix precursors and deposit samples, according to one or more embodiments of the disclosed subject matter.

FIG. 3A is a plan view of an exemplary substrate with sample spot mapping, according to one or more embodiments of the disclosed subject matter.

FIG. 3B is a simplified cross-sectional view of an exemplary substrate with samples deposited thereon, according to one or more embodiments of the disclosed subject matter.

FIG. 3C is a simplified cross-sectional view of an exemplary substrate having an intervening layer with samples deposited thereon, according to one or more embodiments of the disclosed subject matter.

FIG. 3D is a simplified cross-sectional view of an exemplary substrate having an intervening layer with samples deposited thereon and individual top electrodes, according to one or more embodiments of the disclosed subject matter.

FIG. 3E is a simplified cross-sectional view of an exemplary substrate having individual sample deposition supports, according to one or more embodiments of the disclosed subject matter.

FIG. 3F is a simplified cross-sectional view of an exemplary setup with multiple substrates having samples deposited thereon, according to one or more embodiments of the disclosed subject matter.

FIG. 4A is a graph of an exemplary temperature profile for a heating element, according to one or more embodiments of the disclosed subject matter.

FIG. 4B is a simplified cross-sectional view illustrating operation of sequential sintering of sample spots on a substrate, according to one or more embodiments of the disclosed subject matter.

FIG. 4C is a simplified cross-sectional view illustrating operation of parallel sintering of sample spots on a substrate, according to one or more embodiments of the disclosed subject matter.

FIG. 5A illustrates an exemplary evaluation device employing a scanning probe cell, according to one or more embodiments of the disclosed subject matter.

FIG. 5B illustrates an exemplary evaluation device employing a plurality of pogo pins, according to one or more embodiments of the disclosed subject matter.

FIG. 5C illustrates an exemplary evaluation device employing sequential optical irradiation and detection, according to one or more embodiments of the disclosed subject matter.

FIG. 5D illustrates an exemplary evaluation device employing parallel optical irradiation and detection, according to one or more embodiments of the disclosed subject matter.

FIG. 6A is a process flow diagram of an exemplary method for material synthesis and screening via sequential deposition of precursors, according to one or more embodiments of the disclosed subject matter.

FIG. 6B is a process flow diagram of an exemplary method for material synthesis and screening via deposition of premixed precursors, according to one or more embodiments of the disclosed subject matter.

FIG. 6C is a process flow diagram of an exemplary method for material synthesis and screening via simultaneous deposition of different precursors, according to one or more embodiments of the disclosed subject matter.

FIG. 7 depicts a generalized example of a computing environment in which the disclosed technologies may be implemented.

FIG. 8A is an image of a printing nozzle depositing liquid phase precursors on a carbon support in a fabricated example.

FIG. 8B is an image of thermal shock synthesis (˜1650 K, 500 ms) of the liquid phase precursors on the carbon support in a fabricated example.

FIGS. 9A-9B are graphs of particle size and dispersal density, respectively, of multimetallic nanoclusters formed by the thermal shock of FIG. 8B as compared to other synthesis techniques (circled).

FIG. 10A is a graph of X-ray powder diffraction (XRD) measurements for ternary, quinary, and octonary MMNCs.

FIG. 10B shows the synchrotron XRD (λ=0.2113 Å) profile of a fabricated MMNC of PtPdRh.

FIG. 11A is a graph illustrating screening of PtPd-based MMNCs for catalytic oxygen reduction reaction (ORR) (22 compositions+1 blank, 0.1 M KOH, 5 mV/s scan rate).

FIG. 11B illustrates a neural network diagram for compositional designs and their corresponding ORR performances, with circle size representing magnitude of the specific current at 0.45 V for ORR.

FIG. 11C shows the synchrotron XRD profiles for PtPdRhNi and PtPdFeCoNi.

FIG. 12A shows a cycle voltammogram of three fabricated MMNC samples for ORR.

FIG. 12B shows a linear sweep voltammogram of the three fabricated MMNC samples of FIG. 12A.

FIG. 12C shows a Tafel analysis of the three fabricated MMNC samples of FIG. 12A.

FIG. 12D shows the results of a stability test for the three fabricated MMNC samples of FIG. 12A.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein, but are not intended to be limiting. For example, certain terms may be used such as “inner,” “outer,”, “upper,” “lower,” “top,” “bottom,” “interior,” “exterior,” “left,” right,“ “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part and the object remains the same.

As used herein, “comprising” means “including,” and the singular forms “a” or “an” or “the” include plural references unless the context clearly dictates otherwise. The term “or” refers to a single element of stated alternative elements or a combination of two or more elements, unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following explanations of specific terms and abbreviations are provided to facilitate the description of various aspects of the disclosed subject matter and to guide those skilled in the art in the practice of the disclosed subject matter.

Thermal shock: Application of a sintering temperature for a time period having a duration less than about 60 seconds. In some embodiments, the duration of the time period of sintering temperature application is in a range of about 0.5 seconds to about 30 seconds, inclusive.

Sintering temperature: A maximum temperature at a surface of a heating element when energized (e.g., by application of a current pulse). In some embodiments, the sintering temperature is at least about 500° C., for example, in a range of about 1000 to about 3000° C. In some embodiments, a temperature at a material being sintered (e.g., precursors on a substrate) within the furnace can match or substantially match (e.g., within 10%) the temperature of the heating element.

Particle size: A maximum cross-sectional dimension (e.g., diameter) of particle. In some embodiments, an identified particle size represents an average particle size for all particles in a particular sample (e.g., an average of the maximum cross-sectional dimensions).

Nanoparticle: A particle composed of at least two different elements and having a particle size less than or equal to about 1 μm. In some embodiments, each nanoparticle has a size of about 100 nm or less, for example, about 25 nm or less.

Nanocluster: A particle composed of at least two different elements and having a particle size less than or equal to about 2 nm.

Bulk material: A material composed of at least two different elements and having at least one dimension greater than or equal to about 1 mm.

Precursor: One or more materials that, when subjected to thermal shock, are converted to a nanoparticle, nanocluster, or bulk material. In some embodiments, the precursors can comprise metal salts and/or metal oxides that, when subjected to thermal shock, are converted to a homogeneous mixture of metals. Alternatively or additionally, the precursors can be converted via thermal shock to a ceramic (e.g., oxide, nitride, etc.), carbon, heterogeneous or hybrid structure, composite, metal, or any combination of the foregoing.

Refractory material: A material (e.g., element or compound) having a melting temperature of at least 1000 ° C., for example, at least 1580° C. In some embodiments, a refractory material can be as defined in ASTM C71-01, “Standard Terminology Relating to Refractories,” August 2017, which is incorporated herein by reference.

Refractory metal: A metal or metal alloy having a melting point of at least 1000° C., for example, at least 1850° C. In some embodiments, a refractory metal is one of niobium, molybdenum, tantalum, tungsten, rhenium, or an alloy thereof.

Metal: Includes those individual chemical elements classified as metals on the periodic table, including alkali metals, alkaline earth metals, transition metals, lanthanides, and actinides, as well as alloys formed from such metals, such as, but not limited to, stainless steel, brass, bronze, monel, etc.

### Introduction

In one or more embodiments, a combinatorial approach can provide parallel (or pseudo-parallel) synthesis of a large number (e.g., tens, hundreds, thousands, etc.) of samples of different material compositions comprised of multiple elements (e.g., at least two, such as three or more), thereby saving tremendous time and effort. In some embodiments, all of the samples (or at least a subset thereof) can be provided on a common substrate, for example, for part of the synthesis process (e.g., simultaneous or sequential thermal shock of each sample spot on the substrate) and/or subsequent screening (e.g., simultaneous or sequential testing of each sample spot on the substrate). After synthesis, high throughput screening can rapidly acquire data indicative of one or more properties of these compositionally different multielement materials (e.g., nanoparticles, nanoclusters, or functional bulk materials). By combining combinatorial synthesis and high throughput screening, rapid material discovery and exploration in new multielement dimensions becomes possible.

One or more embodiments can include (a) multielement composition design, (b) a combinatorial precursor mapping for a large number (e.g., at least 20, at least 50, at least 100, or at least 1000) of different compositions, (c) thermal shock heating that synthesizes materials with similar structures (e.g., particle size, particle dispersion density, single phase, homogeneous distribution, etc.) despite otherwise different compositions; and (d) high throughput screening of compositionally different samples with respect to targeted properties. In some embodiments, the multielement composition design can comprise selection of particular elements for combination (e.g., from a subset of Pt, Pd, Rh, Ru, Ir, Fe, Co, Au, Mn, and Ni) and/or selection of number of elements per particle (e.g., three elements per particle) or a range of number of elements per particle (e.g., in a range of three to eight elements per particle).

In some embodiments, the combinatorial precursor mapping can include varying element compositions in a spatial arrangement (e.g., composition of one element varying in a stepwise gradual manner along one linear dimension, for example, an element composition for a plurality of samples varying from 1% at one end of the substrate to 99% at an opposite end of the substrate in increments of 1%) or any other predetermined manner. For example, the mapping can utilize a mathematical object in which all possible combinations of elements are covered at least once, similar to a covering array. Alternatively or additionally, a combinatorial algorithm, such as group testing algorithms, can be employed to determine variations of element compositions of the multielement materials for analysis, either formed on a common substrate or spread across multiple substrates.

In some embodiments, the thermal shock heating can be performed on multiple sample spots at time, for example, to simultaneously form multielement materials on the substrate having different material compositions for analysis. For example, the systems and methods for thermal shock heating and/or the multielement materials formed by thermal shock heating can be similar to those disclosed in U.S. Publication No. 2018/0369771, entitled “Nanoparticles and systems and methods for synthesizing nanoparticles through thermal shock,” U.S. Publication No. 2019/0161840, entitled “Thermal shock synthesis of multielement nanoparticles,” International Publication No. WO 2020/236767, entitled “High temperature sintering systems and methods,” and International Publication No. WO 2020/252435, entitled “Systems and methods for high temperature synthesis of single atom dispersions and multi-atom dispersions,” all of which are incorporated by reference herein.

In some embodiments, the high throughput screening can evaluate the plurality of multielement samples on the substrate with respect to one or more properties, such as but not limited to electrical properties (e.g., conductivity, resistance, impedance, etc.), chemical properties (e.g., catalytic or electrocatalytic effect, electrochemical impedance, etc.), optical property (e.g., plasmonic effect, fluorescence, etc.), or any combination thereof. In some embodiments, the high throughput screening can interrogate and evaluate each multielement sample spot on the substrate individually, for example, in a sequential manner. Alternatively or additionally, in some embodiments, the high throughput screening can interrogate and evaluate each multielement sample spot on the substrate collectively, for example, in a parallel manner.

Some embodiments can further include (e) integrating feedback from the screening to direct selection of multielement compositions for further combinatorial synthesis and screening (e.g., by repeating (a)-(d)). For example, once one or more samples are identified as potential options for the predetermined application during an initial iteration of the combinatorial synthesis and screening, a smaller region of diversity space around the one or more identified samples can be probed by a subsequent iteration of the combinatorial synthesis and screening to find improved or additional options. In some embodiments, the feedback can employ optimization algorithms (e.g., a genetic algorithm), data mining, and/or machine learning to determine sample compositions for further screening and/or use in the predetermined application. Some embodiments can further include (f) selection of one or more compositions based on the one or more screenings for use in the predetermined application. Such applications can include but are not limited to use as (i) a catalyst, (ii) a plasmonic nanoparticle, (iii) an energy storage device, (iv) an optoelectronic device, (v) a solid-state electrolyte, (vi) an ion conductive membrane, (vii) a fluorescent material, (viii) a component of any of (i)-(vii), or any combination of (i)-(viii).

### Exemplary Multielement Material Synthesis and Screening Systems

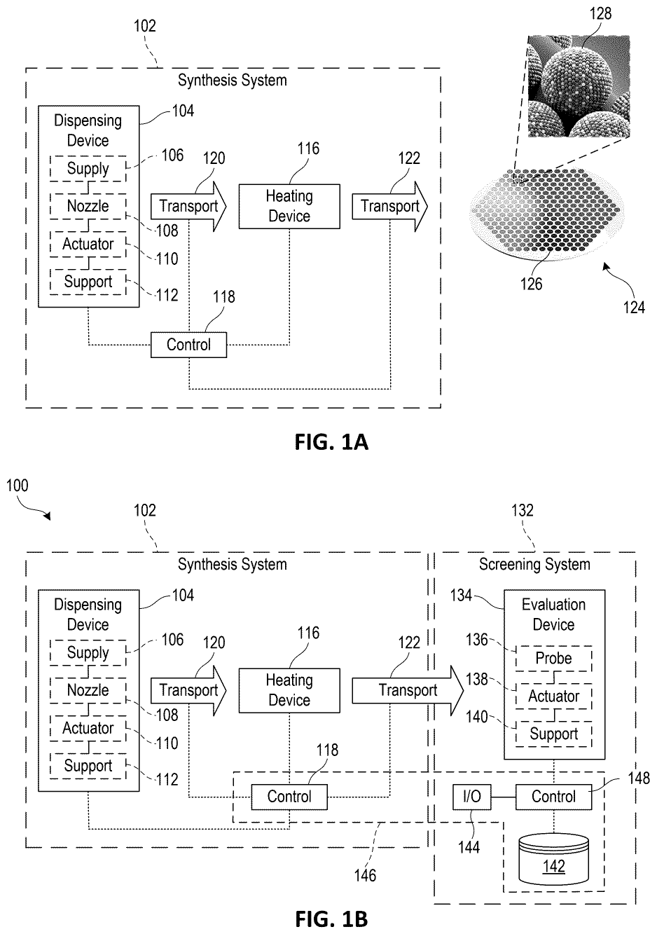

FIG. 1A illustrates an exemplary synthesis system 102. In the illustrated example, the synthesis system 102 can comprise a dispensing device 104 and a heating device 116. The dispensing device 104 can comprise a supply of one or more precursors 106 and a dispensing nozzle 108. The precursor supply 106 can include, for example, one or more reservoirs of salts or oxides (e.g., metal salts or oxides) in solution (e.g., organic solvent, such as ethanol, methanol, isopropyl alcohol (IPA), or acetone). In some embodiments, the concentration of precursors within the reservoirs can be at a level that allows dispensing from the nozzle as a liquid (e.g., a low density), for example, when formation of nanoclusters or nanoparticles is desired. Alternatively or additionally, in some embodiments, the concentration of precursors within the reservoirs can be higher (e.g., with less solution), such that the precursors are dispensed from the nozzle as an ink or slurry, for example, when formation of a bulk material is desired. Alternatively or additionally, in some embodiments, the precursors can be in various states, such as in a vapor state or microparticles.

In some embodiments, the dispensing device 104 can also include a support 112, for example, a movable or stationary platform where a substrate can be disposed. The dispensing device 104 can further include one or more actuators 110. In some embodiments, the actuator(s) 110 can be coupled to nozzle 108 to position the nozzle 108 with respect to the substrate. Alternatively or additionally, in some embodiments, the actuator(s) 110 can be coupled to support 112 to position the substrate with respect to the nozzle 108. The actuator(s) 110 can thus provide motion in at least one dimension, for example, two dimensions parallel to a deposition surface of the substrate, or, in some embodiments, three dimensions (e.g., to change a vertical spacing between the nozzle 108 and the deposition surface of the substrate). In some embodiments, the dispensing device 104 can be an ink jet printhead, an additive manufacturing printhead (e.g., 3D printer), a robotic pipetting device, or any other mechanism for controlled dispensing of fluids (e.g., inks, suspensions, slurries, etc.).

The heating device 116 can be constructed to apply a thermal shock, for example, by providing a temperature in excess of 500° C. (e.g., in a range of 1000-3000° C., inclusive) for a time period less than 60 seconds (e.g., in a range of 0.5 to 30 seconds, inclusive). In some embodiments, the heating device 116 can comprise a Joule heating (e.g., with the heating element in contact with the precursors to provide conductive heating and/or spaced from the precursors to provide radiation heating), microwave heating, laser heating, plasma heating, or any combination thereof.

In some embodiments, the synthesis system 102 can include one or more transport mechanisms 120 to convey the substrate from the dispensing device 104 to the heating device 116. Alternatively or additionally, the synthesis system 102 can include one or more transport mechanisms 122 to convey the substrate from the heating device 116. In some embodiments, the transport mechanism 122 may be combined with and/or considered part of transport mechanism 120. Alternatively, in some embodiments, transport mechanism 122 may be separate from and/or operate independently of transport mechanism 120. For example, in some embodiments, the transport mechanism 120, transport mechanism 122, or both can comprise a conveyor system (e.g., comprising one or more belts and/or rollers).

Alternatively or additionally, in some embodiments, either or both of the transport mechanisms 120, 122 can comprise a pick-and-place robot, magnetic actuators, pneumatic or vacuum actuators, or any other transport mechanism.

Synthesis system 102 can further include a control sub-system 118, which can be operatively coupled to the various components of synthesis system 102, e.g., dispensing device 104, heating device 116, and/or transport mechanisms 120, 122, to direct operation thereof. For example, the control sub-system 118 can control the dispensing device 104 to dispense precursors at a plurality of sample spots on the substrate with different elemental compositions according to a combinatorial approach. After dispensing of the precursors, the control sub-system 118 can direct transport mechanism 120 to move the substrate to heating device 116 and to control the heating device 116 to generate a thermal shock. The thermal shock can be effective to convert the precursors at each sample spot 126 to a substantially homogeneous solid mixture of multiple elements (e.g., multielement material, such as multielement nanoparticle 128). Since the precursors were loaded across the substrate 124 according to the combinatorial approach, each of the sample spots can have a different material composition. Despite the different material compositions, the thermal shock treatment can be effective to generate materials that otherwise have substantially similar particle sizes and uniformity, which features can be useful for subsequent screening and comparison of material properties.

The control sub-system 118 can direct transport mechanism 122 to move the substrate 124, with sample spots having different material compositions thereon, from the heating device 116 for subsequent screening, for example, via a separate screening system or via an integrated screening system. For example, FIG. 1B illustrates an exemplary system 100 comprising synthesis system 102 and a screening system 132. In the illustrated example, screening system 132 can comprise an evaluation device 134. The evaluation device 134 can comprise a probe head 136, for example, to make electrical, electrochemical, or mechanical contact with a particular sample spot or to otherwise interrogate (e.g., by directing optical radiation at) with a particular sample spot on the substrate. The evaluation device 134 can be configured to measure an electrical property, a chemical property, and/or an optical property of the interrogated sample spot.

In some embodiments, the evaluation device 134 can also include a support 140, for example, a movable or stationary platform where the substrate can be disposed. The evaluation device 134 can further include one or more actuators 138. In some embodiments, the actuator(s) 138 can be coupled to probe head 136 to position the probe head 136 with respect to the substrate. Alternatively or additionally, in some embodiments, the actuator(s) 138 can be coupled to support 140 to position the substrate with respect to the probe head 136. The actuator(s) 138 can thus provide motion in at least one dimension, for example, two dimensions parallel to a deposition surface of the substrate, or, in some embodiments, three dimensions (e.g., to change a vertical spacing between the probe head 136 and the sample spots on the substrate). In some embodiments, the evaluation device 134 is configured to perform parallel testing of sample spots, for example, to interrogate multiple sample spots at once. For example, optical radiation can be directed at multiple spots on the substrate, and the multiple spots imaged simultaneously. Alternatively or additionally, in some embodiments, the evaluation device 134 operates in a serial manner, for example, by testing a single sample spot at a time.

Screening system 132 can further include a control sub-system 148, which can be operatively coupled to the various components of screening system 132, e.g., evaluation device 134, input/output (I/O) interface 144, and/or database 142, to direct operation thereof. In some embodiments, control sub-system 148, control sub-system 118, I/O interface 144, and/or database 142 can be considered part of a system-wide control system 146. Alternatively, in some embodiments, control sub-system 148 and control sub-system 118 may be considered separate from each other, although in some cases the control sub-systems may communicate with each other, for example, to coordinate transfer of a substrate from synthesis system 102 and screening system 132 via transport mechanism 122.

In some embodiments, the control sub-system 148 can control the evaluation device 134 to test one, some, or all of the sample spots on the substrate with respect to one or more material properties. The resulting data can be stored in database 142 for further processing. Alternatively or additionally, in some embodiments, the control sub-system 148 can be configured to analyze the data to determine an optimal material composition for a particular application. In some embodiments, the control sub-system 148 can provide feedback to synthesis system 102 (e.g., via communication with control sub-system 118) regarding material compositions that should be further investigated in a subsequent combinatorial synthesis iteration, for example, by investigating material compositions in a vicinity of a highest scoring material from a prior combinatorial synthesis run. Alternatively or additionally, the control sub-system 148 can employ data mining techniques and/or machine learning (e.g., with or without consideration of data from prior combinatorial synthesis runs stored in database 142) to identify material compositions that should be further investigated in a subsequent combinatorial synthesis iteration. Alternatively or additionally, the control sub-system 148 may simply select one of the tested sample spots from the substrate that has the best material properties for the particular application (or a set of test sample spots that have the top material properties). I/O interface 144 can be used to communicate results of the screening to a human user (e.g., via a graphical display) and/or to accept input from a human user (e.g., to direct material compositions of a subsequent combinatorial synthesis iteration and/or control system operations).

### Exemplary Precursor Dispensing Devices

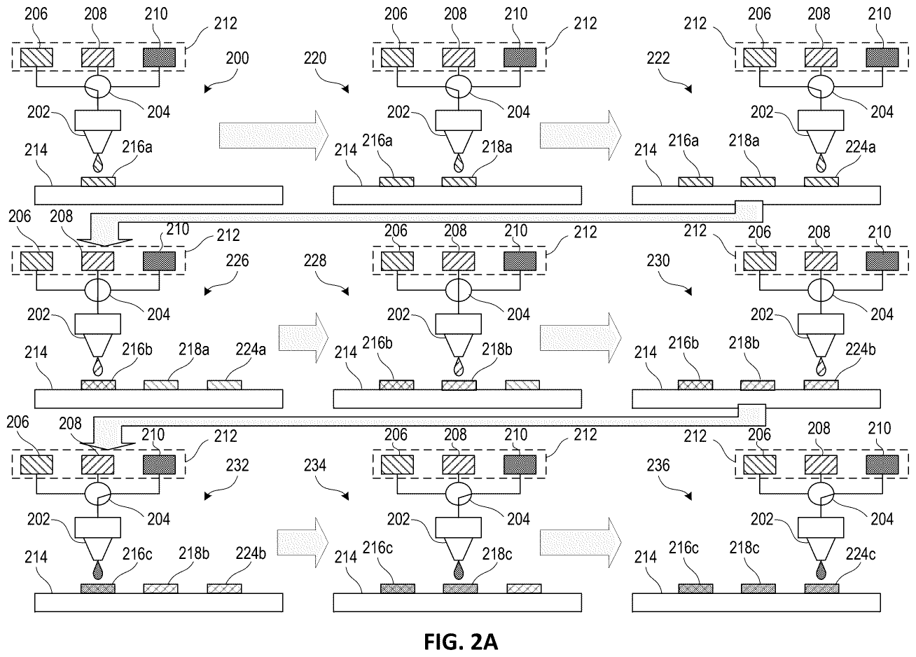

FIG. 2A illustrates an exemplary operation for dispensing of precursors on substrate 214 via nozzle 202. A supply 212 of multiple precursors can be fluidically coupled to the nozzle 202 via multi-position valve 204. In the illustrated example, supply 212 has a first reservoir 206 for a first precursor, a second reservoir 208 for a second precursor, and a third reservoir 210 for a third precursor; however, the supply 212 can include any number of reservoirs, for example, corresponding to the number of different precursors required to form the different material combinations according to the combinatorial approach (e.g., three to eight precursors corresponding to three to eight elements in each multielement material). Indeed, the example of FIG. 2A illustrates three precursors and corresponding deposited spots for simplicity only, but practical embodiments may include more than three precursors and more deposited spots (e.g., on the order of 10s, 100s, or even 1000s). Moreover, although the example of FIG. 2A suggests deposition of precursor on each sample spot, embodiments of the disclosed subject matter are not limited thereto. Rather, a precursor can be applied to one, some, or all of the sample spots, depending on the details of the designed combinatorial approach.

At stage 200, nozzle 202 can be aligned with a first spot location, for example, by moving nozzle 202 with respect to substrate 214, by moving substrate 214 with respect to the nozzle 202, or both. A predetermined first amount of first precursor (e.g., corresponding to a desired composition of the ultimate multielement material corresponding to the spot location) can be dispensed from first reservoir 206 to the first spot location via nozzle 202, thereby forming first sample 216a. As shown at stage 220, the nozzle 202 can then be aligned with a second spot location, for example, by moving the nozzle 202 and/or the substrate 214, and a predetermined second amount of first precursor (which second amount may be different than that of the first precursor sample 216a) can be dispensed from first reservoir 206 to the second spot location via nozzle 202, thereby forming second sample 218a. As shown at stage 222, the nozzle 202 can then be aligned with a third spot location, for example, by moving the nozzle 202 and/or the substrate 214, and a predetermined third amount of first precursor (which third amount may be different than that of first sample 216a and/or second sample 218a) can be dispensed from first reservoir 206 to the third spot location via nozzle 202, thereby forming third sample 224a.

The nozzle 202 can then reconfigure for deposition of the second precursor on the same spot locations (e.g., thereby mixing the precursors in place on the substrate). For example, the valve 204 can switch orientations to couple the second reservoir 208 of supply 212 to nozzle 202. At stage 226, nozzle 202 can be re-aligned with the first spot location by moving the nozzle 202 and/or the substrate 214, and a predetermined fourth amount of second precursor (e.g., corresponding to a desired composition of the ultimate multielement material corresponding to the spot location) can be dispensed from second reservoir 208 to the first spot location via nozzle 202, thereby forming a first mixed sample 216b (e.g. formed of a first amount of first precursor and a fourth amount of second precursor). As shown at stage 228, the nozzle 202 can then be re-aligned with the second spot location, for example, by moving the nozzle 202 and/or the substrate 214, and a predetermined fifth amount of second precursor (which fifth amount may be different than the fourth amount of second precursor in sample 216b) can be dispensed from second reservoir 208 to the second spot location via nozzle 202, thereby forming second mixed sample 218b. As shown at stage 230, the nozzle 202 can then be re-aligned with the third spot location, for example, by moving the nozzle 202 and/or the substrate 214, and a predetermined sixth amount of second precursor (which sixth amount may be different than the fourth amount of second precursor in sample 216b and/or the fifth amount of second precursor in sample 218b) can be dispensed from second reservoir 208 to the third spot location via nozzle 202, thereby forming third mixed sample 224b.

The nozzle 202 can then reconfigure again for deposition of the third precursor on the same spot locations (e.g., thereby mixing the precursors in place on the substrate). For example, the valve 204 can switch orientations to couple the third reservoir 210 of supply 212 to nozzle 202. At stage 232, nozzle 202 can be re-aligned with the first spot location by moving the nozzle 202 and/or the substrate 214, and a predetermined seventh amount of third precursor (e.g., corresponding to a desired composition of the ultimate multielement material corresponding to the spot location) can be dispensed from third reservoir 210 to the first spot location via nozzle 202, thereby forming a first final sample 216c (e.g. formed of a combination of a first amount of first precursor, a fourth amount of second precursor, and a seventh amount of third precursor). As shown at stage 234, the nozzle 202 can then be re-aligned with the second spot location, for example, by moving the nozzle 202 and/or the substrate 214, and a predetermined eighth amount of third precursor (which eighth amount may be different than the seventh amount of third precursor in sample 216c) can be dispensed from third reservoir 210 to the second spot location via nozzle 202, thereby forming second final sample 218c. As shown at stage 236, the nozzle 202 can then be re-aligned with the third spot location, for example, by moving the nozzle 202 and/or the substrate 214, and a predetermined ninth amount of third precursor (which ninth amount may be different than the seventh amount of third precursor in sample 216c and/or the eighth amount of third precursor in sample 218c) can be dispensed from third reservoir 210 to the third spot location via nozzle 202, thereby forming third final sample 224c.

The reconfiguration of nozzle 202 and deposition of precursor can be repeated any number of times according to the composition defined by the combinatorial approach. After depositing of all sample spots, the substrate 214 can be subjected to thermal shock as described elsewhere herein, so as to form an array of multielement materials of different compositions on the substrate for subsequent screening. Alternatively, in some embodiments, after dispensing of one precursor (e.g., after deposition of first precursor in stage 222, after deposition of second precursor in stage 230, and/or after deposition of third precursor in stage 236) on all desired spots of the substrate 214, the substrate 214 can be subjected to thermal shock or at least to a thermal treatment prior to beginning dispensing of the next precursor. In some embodiments, such independent treatment of the precursors may help in mixing the elements of the deposited precursor with elements from subsequent precursor depositions. Alternatively or additionally, the system can proceed with deposition of additional precursor depositions on spot locations without an intervening thermal shock.

In some embodiments, instead of independent deposition of separate precursors on each spot location on the substrate, precursors can be premixed according to desired compositions and then applied directly to a corresponding spot location. For example, FIG. 2B illustrates an exemplary operation for dispensing of pre-mixed precursors on substrate 214 via nozzle 202. Similar to FIG. 2A, a precursor supply 242 having three reservoirs 244, 246, 248 can be fluidically coupled to nozzle 202 via a multi-position valve 204. However, instead of a single precursor in each reservoir, supply 242 maintains a different combination of precursors in each reservoir. For example, first reservoir 244 can have a first ratio of multiple precursors (e.g., three or more) corresponding to a first spot location, second reservoir 246 can have a second ratio of the multiple precursors corresponding to a second spot location, and third reservoir 248 can have a third ratio of the multiple precursors corresponding to a third spot location.

Although FIG. 2B illustrates only three reservoirs, supply 242 can include any number of reservoirs, for example, corresponding to the number of different spot locations and/or the number of different combinations to be deposited on the substrate for screening. Indeed, the example of FIG. 2B illustrates three reservoirs and corresponding deposited spots for simplicity only, but practical embodiments may include more than three reservoirs and more deposited spots (e.g., on the order of 10s, 100s, or even 1000s). Moreover, although the example of FIG. 2B suggests deposition from one reservoir on a single sample spot, embodiments of the disclosed subject matter are not limited thereto. Rather, mixed precursors from a reservoir can be deposited on multiple spots, for example, to provide the samples with the same compositions for redundant testing and/or to provide different material compositions (e.g., in a manner similar to that described with FIG. 2A above or FIG. 2C below).

At stage 240, nozzle 202 can be aligned with a first spot location, for example, by moving nozzle 202 with respect to substrate 214, by moving substrate 214 with respect to the nozzle 202, or both. A predetermined amount of first premixed precursors (e.g., corresponding to a desired composition of the ultimate multielement material corresponding to the spot location) can be dispensed from first reservoir 244 to the first spot location via nozzle 202, thereby forming first sample 250. As shown at stage 254, the nozzle 202 can then be aligned with a second spot location, for example, by moving the nozzle 202 and/or the substrate 214, and the valve 204 can switch orientations to couple the second reservoir 246 of supply 242 to nozzle 202. A predetermined amount of second premixed precursor (which amount may be substantially the same as that of the first premixed precursor forming first sample 250) can then be dispensed from second reservoir 246 to the second spot location via nozzle 202, thereby forming second sample 252.

As shown at stage 258, the nozzle 202 can then be aligned with a third spot location, for example, by moving the nozzle 202 and/or the substrate 214, and the valve 204 can switch orientations to couple the third reservoir 248 of supply 242 to nozzle 202. A predetermined amount of third premixed precursor (which amount may be substantially the same as that of the first premixed precursor forming first sample 250 and/or the second premixed precursor forming second sample 252) can then be dispensed from third reservoir 248 to the third spot location via nozzle 202, thereby forming third sample 256. After depositing of all sample spots, the substrate 214 can be subjected to thermal shock as described elsewhere herein, so as to form an array of multielement materials of different compositions on the substrate for subsequent screening.

In some embodiments, instead of premixing precursors, the precursors can be mixed from separate supplies according to desired compositions en route or just prior to dispensing via nozzle (e.g., on-the-fly mixing). For example, FIG. 2C illustrates an exemplary operation for dispensing of on-the-fly mixed precursors on substrate 214 via nozzle 202. Similar to FIG. 2A, precursor supply 272 can have three reservoirs 266, 268, 270 with different precursors contained therein. However, instead of a multi-position valve 204, each reservoir 266, 268, 270 can have a respective valve 264a, 264b, 264c that regulates flow therefrom to mixing conduit 262 and/or nozzle 202 to achieve a desired ratio of precursors corresponding to the particular spot location.

Although FIG. 2C illustrates only three reservoirs, supply 272 can include any number of reservoirs, for example, corresponding to the number of different precursors required to form the different material combinations according to the combinatorial approach (e.g., three to eight precursors corresponding to three to eight elements in each multielement material). Indeed, the example of FIG. 2C illustrates three precursors and corresponding deposited spots for simplicity only, but practical embodiments may include more than three precursors and more deposited spots (e.g., on the order of 10s, 100s, or even 1000s). Moreover, although the example of FIG. 2C suggests inclusion of each precursor in the deposited mixture on each sample spot, embodiments of the disclosed subject matter are not limited thereto. Rather, a precursor can be included in one, some, or all of the deposited mixtures, depending on the details of the designed combinatorial approach.

At stage 260, nozzle 202 can be aligned with a first spot location, for example, by moving nozzle 202 with respect to substrate 214, by moving substrate 214 with respect to the nozzle 202, or both. Flow from each reservoir 266-270 can be controlled via the respective valves 264a-264c to provide a desired first ratio of precursors (e.g., corresponding to a desired composition of the ultimate multielement material corresponding to the first spot location) to mixing conduit 262. The resulting first mixture of precursors can thus be dispensed to the first spot location via nozzle 202, thereby forming first sample 274. As shown at stage 278, the nozzle 202 can then be aligned with a second spot location, for example, by moving the nozzle 202 and/or the substrate 214. Flow from each reservoir 266-270 can be controlled via the respective valves 264a-264c to provide a desired second ratio of precursors (e.g., corresponding to a desired composition of the ultimate multielement material corresponding to the second spot location) to mixing conduit 262. The resulting second mixture of precursors can then be dispensed to the second spot location via nozzle 202, thereby forming second sample 276. Similarly, as shown at stage 282, the nozzle 202 can then be aligned with a third spot location, for example, by moving the nozzle 202 and/or the substrate 214. Flow from each reservoir 266-270 can be controlled via the respective valves 264a-264c to provide a desired third ratio of precursors (e.g., corresponding to a desired composition of the ultimate multielement material corresponding to the third spot location) to mixing conduit 262. The resulting third mixture of precursors can then be dispensed to the third spot location via nozzle 202, thereby forming third sample 280. After depositing of all sample spots, the substrate 214 can be subjected to thermal shock as described elsewhere herein, so as to form an array of multielement materials of different compositions on the substrate for subsequent screening.

Although the description of examples of FIGS. 2A-2C is primarily directed to sequential deposition by a single nozzle, other sequential or parallel deposition techniques are also possible. For example, an array of nozzles can be provided to independently dispense the same or different precursors on different spot locations in parallel. Alternatively or additionally, multiple nozzles can be provided to dispense sequentially or simultaneously dispense precursors on a single spot location. Moreover, although the description of examples of FIGS. 2A-2C suggests that thermal shock is performed after deposition of precursors, one or more intermediate processing steps may be provided after the deposition and prior to the thermal shock. For example, in some embodiments, the deposited precursors can be dried (e.g., via evaporation of the solvent in which the precursors are carried to the spot location) prior to being subjected to the thermal shock.

### Exemplary Substrate Configurations

In some embodiments, a plurality of sample spots with different material compositions can be formed on a substrate according to a combinatorial approach. For example, combinatorial precursor mapping can be employed to provide a large number (e.g., at least 20, at least 50, at least 100, or at least 1000) of different compositions on the substrate for subsequent screening. In some embodiments, the combinatorial precursor mapping can include varying element compositions in a spatial arrangement (e.g., composition of one element varying in a stepwise gradual manner along one linear dimension).

The substrate can have any shape or configuration, but generally can have a least one exposed substantially-planar surface for deposition of sample spots of precursors thereon. Alternatively, in some embodiments, precursors can be deposited on an intervening material of the substrate (e.g., a metal electrode layer) or a deposition platform (e.g., carbon micro-disk) coupled to the substrate. In some embodiments, the substrate is formed of a material that can withstand exposure to the sintering temperature, for example, carbon, graphite, a refractory material (e.g., refractory metal), etc. Alternatively, in some embodiments where the precursors are sintered using deposition platforms and subsequently coupled to the substrate, the substrate is formed of a material that cannot withstand exposure the sintering temperature, for example, a metal (e.g., copper), a polymer, a composite, etc.

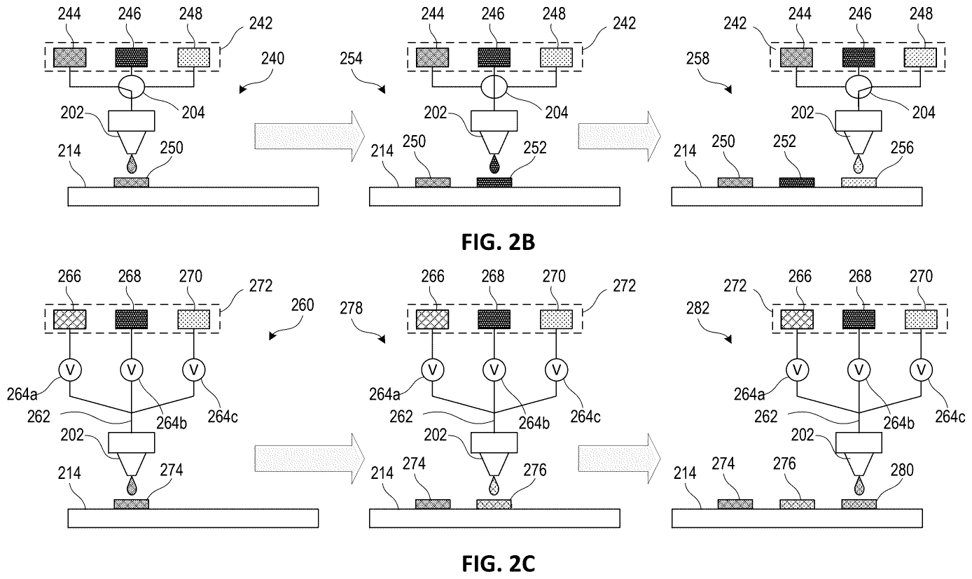

FIG. 3A shows an exemplary mapping configuration 300 for a substrate 302. In the illustrated example of FIG. 3A, the sample spots 304 (e.g., precursor deposition regions) are arranged in a regular hexagonal array on the substantially-circular substrate 302. Precursor concentrations (and resulting material compositions after thermal shock) may vary in a gradual and/or predetermined manner across the surface of the substrate 302. Each sample spot 304 can have a size (e.g., diameter) of w and a spacing (e.g., minimum separating between adjacent spots) of g. In some embodiments, the sample spot size, spot size spacing, or both can be determined by deposition limitations (e.g., nozzle displacement resolution), synthesis limitations (e.g., to avoid cross-contamination), and/or screening limitations (e.g., to allow separate interrogation by probe head and/or detection by evaluation device). For example, in some embodiments, the sample spot size, w, can be less than or equal to 1 mm, and the spacing, g, can be equal to or greater than the sample spot size, w (e.g., g≥w≤1 mm).

In some embodiments, the precursors can be deposited directly on a substrate surface, and the multielement materials formed by the precursors after thermal shock can thus be formed directly on and/or integrated with the substrate. For example, FIG. 3B illustrates a first substrate configuration 310, where each sample spot 314a-314d comprises a separate multielement material 316a-316d formed on and in contact with an upper surface of substrate 312. As discussed elsewhere herein, multielement materials 316a-316d can have different material compositions from each other.

In some embodiments, the precursors can be deposited indirectly on a substrate surface via one or more intermediate layers (e.g., a conductive layer, such as copper, for use in subsequent screening, for example, a common electrode). The multielement materials formed by the precursors after thermal shock can thus be formed on but spaced from a surface of the substrate. For example, FIG. 3C illustrates a second substrate configuration 320, where each sample spot 324a-324d comprises a separate multielement material 326a-326d formed on and in contact with intervening layer 328, which is in turn formed on and optional in contact with an upper surface of substrate 322. As discussed elsewhere herein, multielement materials 324a-324d can have different material compositions from each other.

In some embodiments, one or more additional layers can be deposited directly or indirectly on the multielement materials, e.g., for using in subsequent screening, for example, as an individual electrical contact or electrode. For example, FIG. 3D illustrates a third substrate configuration 330, where each sample spot 334a-334d comprises a separate multielement material 334a-334d formed on and in contact with intervening layer 328, which is in turn formed on and optionally in contact with an upper surface of substrate 332. Separate cap layers 340a-340d can be formed on and in contact with respective upper surfaces of multielement materials 334a-334d. For example, cap layers 340a-340d can be formed of a metal (e.g., Au) and can act as microdot electrodes. As discussed elsewhere herein, multielement materials 334a-334d can have different material compositions from each other.

In some embodiments, the precursors can be deposited on individual platforms which are subsequently coupled to the substrate, for example, after thermal shock treatment (e.g., when the substrate is formed of a material that may not otherwise survive exposure to the high temperature). For example, FIG. 3E illustrates a fourth substrate configuration 350, where each sample spot 354a-354d comprises a separate multielement material 356a-356d formed on and in contact with respective deposition platforms 358a-358d, which are in turn coupled to (e.g., via an adhesive, such as a conductive paste) and optionally in contact with an upper surface of substrate 352 (or an intervening layer formed over the substrate). For example, the deposition platforms 358a-358d can be formed of a high-temperature resistant material, such as carbon (e.g., carbon microdisks) or other refractory materials. As discussed elsewhere herein, multielement materials 356a-356d can have different material compositions from each other.

In some embodiments, the plurality of sample spots can be spread over multiple separate substrates, for example, where the size of a single substrate is otherwise insufficient to accommodate all of the sample spots. For example, FIG. 3F illustrates a fifth substrate configuration 360, where each sample spot 364a-364d comprises a separate multielement material 366a-366d. A first subset comprising multielement materials 366a-366b can be supported by a first substrate 362a, while a second subset comprising multielement materials 366 c-366d can be supported by a second substrate 362b. As discussed elsewhere herein, multielement materials 366a-366d can have different material compositions from each other.

Although FIGS. 3A-3F illustrate a particular number of sample spots, any number of sample spots can be provided on the substrates, for example, corresponding to the number of different material combinations to be screened according to the combinatorial approach. Indeed, the examples of FIGS. 3B-3F illustrate four sample spots for simplicity only, but practical embodiments may include more sample spots (e.g., on the order of 10s, 100s, or even 1000s).

### Exemplary Heating Devices

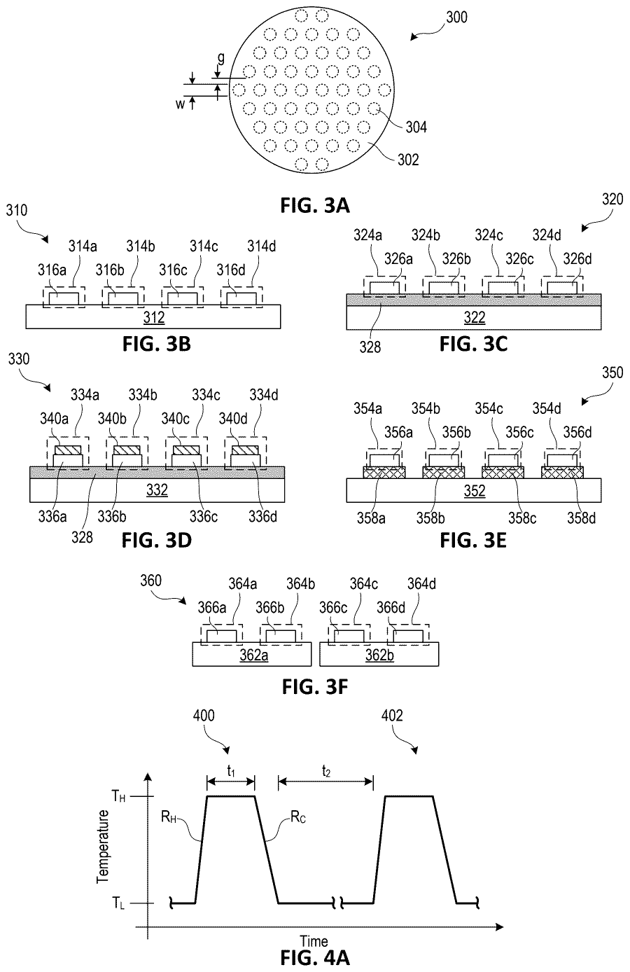

To convert deposited precursors into a substantially homogeneous solid mixture of multiple elements, the precursors can be subjected a thermal shock treatment comprising one or more high temperature pulses. For example, FIG. 4A shows an exemplary temperature profile of a thermal shock treatment. A first heating pulse 400 can be applied to a single sample spot (or multiple sample spots on the substrate in parallel). The heating pulse 400 can provide a high temperature TH (e.g., at least 500° C., such as in a range of 1000-3000° C., inclusive) for a relatively short time period t₁ (e.g., less than or equal to 60 second, such as in a range of 0.5 to 30 seconds, inclusive). In some embodiments, the heating pulse 400 can provide a rapid transition to and/or from the high temperature T_{H}. For example, the heating pulse 400 can exhibit a heating ramp rate R_{H} (e.g., to high temperature T_{H} from a low temperature T_{L}, such as room temperature (e.g. 20-25° C.) or an elevated ambient temperature (e.g., 100-200° C.)) of at least 102 C./s, such as 103-104° C./s, inclusive. Alternatively or additionally, the heating pulse 400 can exhibit a cooling ramp rate RL (e.g., to a low temperature T_{L} from high temperature T_{H}) of at least 102° C./s, such as 10³-10⁴° C./s, inclusive.

After a delay t₂, a second heating pulse 402 (which may be substantially identical to the first heating pulse 400) can be applied to the substrate. In some embodiments, the delay t₂ can of sufficient duration to allow the substrate to be repositioned such that a next sample spot (or set of sample spots) thereon is disposed within the heating zone, for example, to allow conversion of precursors of the next sample spot. In some embodiments, the delay t₂ can be less than a duration of the heating pulse period t₁. Alternatively, the delay t₂ can be substantially equal to or greater than the pulse duration t₁.

In some embodiments, the heating device can be configured to sequentially heat sample spots on the substrate. For example, FIG. 4B illustrates an exemplary operation for heating of precursors on a substrate 408 via heating device 412 (e.g., a Joule heating element). At stage 410, a heating zone 414 (e.g., having a temperature substantially matching a high temperature (e.g., sintering temperature) of the thermal shock pulse when the heating device 412 is energized or active) of heating device 412 can be aligned with a first precursor sample 406a, for example, by moving heating device 412, by moving substrate 408, or both. The heating device 412 can be energized so as to subject the first precursor sample 406a to a thermal shock, thereby converting the precursors into a first multielement material 416a. The heating device 412 can thus proceed to the next precursor sample. At stage 420, the heating zone 414 of heating device 412 can be aligned with a second precursor sample 406b by moving heating device 412 and/or substrate 408 and then subjecting sample 406b to thermal shock to convert it into multielement material 416b. Sequential thermal shock treatments can be provided by aligning heating zone 414 with other samples and energizing the heating device 412 in a similar manner in stages 430, 440 to form additional multielement materials 416a-416d. As discussed elsewhere herein, multielement materials 416a-416d can have different material compositions from each other.

Alternatively or additionally, in some embodiments, the heating device can be configured to heat multiple sample spots on the substrate simultaneously. For example, FIG. 4C illustrates an exemplary operation for heating of precursors on a substrate 408 via heating device 452. At stage 450, a heating zone 454 (e.g., having a temperature substantially matching a high temperature/sintering temperature of the thermal shock pulse when the heating device 412 is energized or active) of heating device 452 can be aligned with multiple precursor samples 406a-406d, for example, by moving heating device 452, by moving substrate 408, or both. The heating device 452 can be energized so as to subject the precursor samples 406a-406d to a thermal shock, thereby converting the precursors into respective multielement materials 416a-416, as shown at stage 460 in FIG. 4C. As discussed elsewhere herein, multielement materials 416a-416d can have different material compositions from each other.

Although FIGS. 4B-4C illustrate a particular number of sample spots, any number of sample spots can be provided on the substrates, for example, corresponding to the number of different material combinations to be screened according to the combinatorial approach. Indeed, the examples of FIGS. 4B-4C illustrate four sample spots for simplicity only, but practical embodiments may include more sample spots (e.g., on the order of 10s, 100s, or even 1000s).

### Exemplary Evaluation Devices

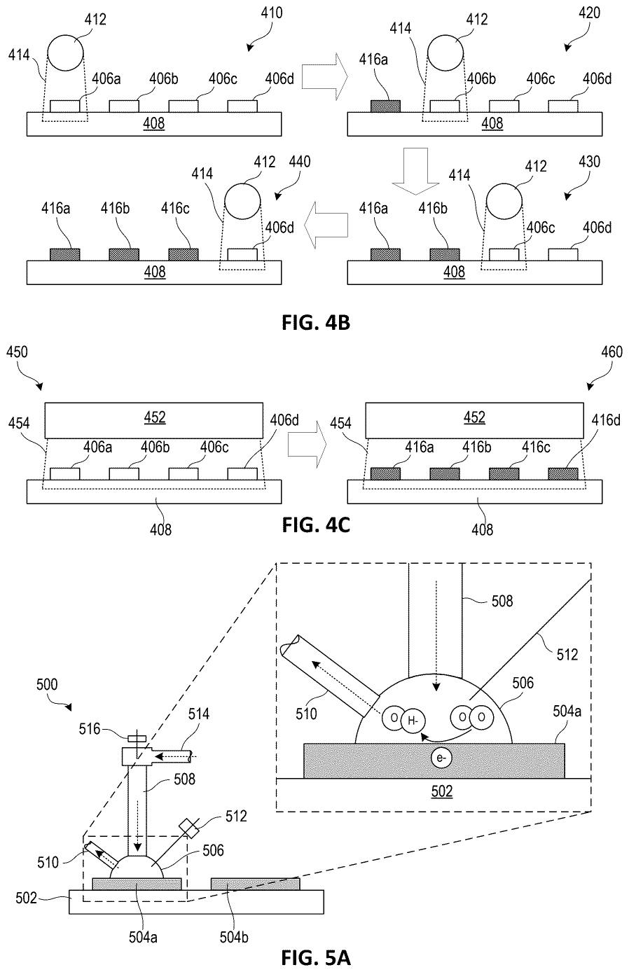

FIG. 5A illustrates an exemplary scanning probe cell configuration 500 that can be used as an evaluation device for electrochemical screening of multielement materials 504a-504b formed on a metal electrode layer 502 (Cu) on a substrate. The scanning probe cell configuration 500 comprises a microreactor 506 that can be moved into contact with different multielement materials 504a-504b on the substrate for testing of each individually. In the illustrated example, the microreactor 506 is disposed over an upper surface of first multielement material 504a. Channels 508, 510 are coupled to the microreactor 506 and are constructed to provide inlet and outlet fluid flows, respectively. An inlet channel 514 is connected to an end of channel 508 remote from microreactor 506 for filling and/or providing fresh electrolyte/solution to the microreactor 506. A reference electrode 516 can also be coupled to the end of channel 508, while a counter electrode 512 can be provided to an interior volume of the microreactor 506, for example, at a location opposite the outlet channel 510. The sample material 504a on metal electrode layer 502 can act as a working electrode, thereby forming a three-electrode setup in the microreactor 506 for rapid electrochemical screening (e.g., by linear scanning sweeps, cycle voltammetry, obtaining electrochemical impedance spectra (EIS), or any other electrocatalytic property characterization). After testing of first material 504a, the next material 504b can be tested, for example, by moving the scanning probe cell configuration 500, by moving the substrate, or both.

FIG. 5B illustrates an exemplary pogo pin testing configuration 520 that can be used as an evaluation device for electrical screening of multielement materials 526a-526d formed on a metal electrode layer 524 on substrate 522. The pogo pin testing configuration 520 comprises a plurality of first pogo pins 530 that contact respective multielement materials 526a-526d. Optionally, the pogo pin testing configuration 520 can comprise one or more pogo pins 528 that contact electrode layer 524, for example, for testing electrical resistance, conductivity, and/or impedance (e.g., which may allow the deconvolution of ionic conductivity contribution from grains and/or grain boundaries) of the fabricated materials 526a-526d. In some embodiments, the pogo pin testing configuration 520 can be configured to test the fabricated materials 526a-526d in parallel. Alternatively or additionally, the pogo pin testing configuration 520 can include circuitry and/or be controlled by software to test the multielement materials 526a-526d sequentially despite the simultaneous contact of pins 530 with the materials 526a-526d.

FIG. 5C illustrates an exemplary optical testing configuration 540 that can be used as an evaluation device for sequential optical screening of multielement materials 544a-544d formed on substrate 542. The optical testing configuration 540 comprises a probe head 546 with an optical source 548 (e.g., laser, laser diode, light-emitting diode (LED), etc.) that emits interrogating light 550 and an optical detector 554 (e.g., photomultiplier tube, photodetector, two-dimensional imaging detector, etc.) for detecting light 552 (e.g., fluorescence) from the first sample 544a. After testing of first material 544a, the next material 544b can be tested, for example, by moving the probe head 546, by redirecting focal points of the light source 548 and/or collection optics of the detector 554, by moving the substrate, or any combination of the foregoing.

FIG. 5D illustrates an exemplary optical testing configuration 560 that can be used as an evaluation device for parallel optical screening of multielement materials 544a-544d formed on substrate 542. Similar to FIG. 5C, the optical testing configuration 560 comprises an optical source 562 that emits interrogating light 564 and an optical detector 570 for detecting light 566. However, the interrogating light 564 is focused to illuminate multiple samples 544a-544d simultaneously, and the detection arm includes collection optics 568 that allows for simultaneous detection of light 566 from multiple samples 544a-544d, which may improve throughput of screening multiple samples.

Although FIGS. 5A-5D illustrate specific examples of an evaluation device, other configurations and/or systems for testing of material properties are also possible according to one or more contemplated embodiments. Moreover, although FIGS. 5A-5D illustrate a particular number of sample spots, any number of sample spots can be provided on the substrates, for example, corresponding to the number of different material combinations to be screened according to the combinatorial approach. Indeed, the example of FIG. 5A illustrates two sample spots and the examples of FIGS. 5B-5D illustrate four sample spots for simplicity only, but practical embodiments may include more sample spots (e.g., on the order of 10s, 100s, or even 1000s).

### Exemplary Multielement Material Synthesis and Screening Methods

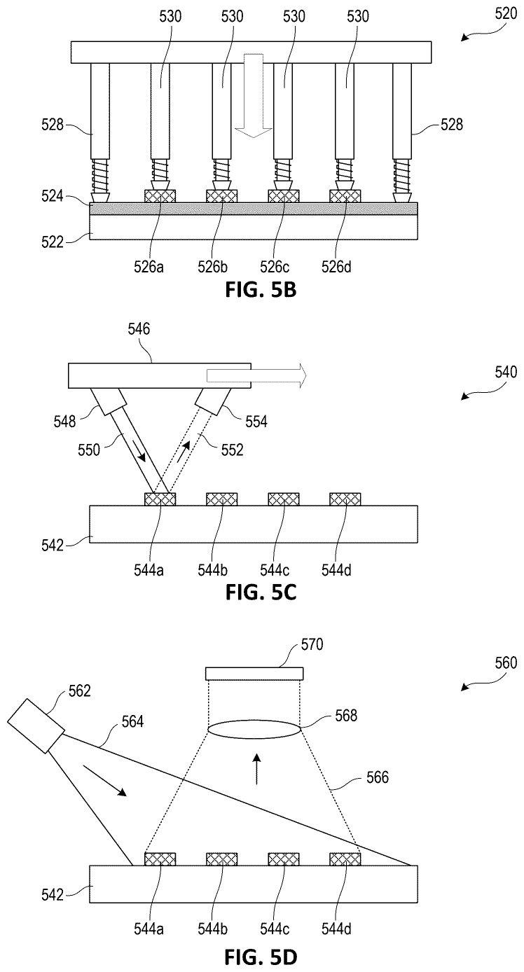

FIG. 6A illustrates an exemplary method 600 for combinatorial synthesis and screening of multielement materials. The method 600 can initiate at process block 602, where a substrate can be provided. For example, the provided substrate can be as described above with respect to any of FIGS. 3A-3F. In some embodiments, the provision of process block 602 can include forming one or more intervening layers on the substrate, for example, a metal electrode layer.

The method 600 can proceed to process block 604, where sample spots with different intended material compositions can be mapped onto the substrate according to a combinatorial approach. At process block 606, a first sample spot on the substrate can be selected, and at process block 608, a first precursor can be deposited on the first sample spot according to the mapped material composition. In some embodiments, the deposition of process block 608 can be performed using a nozzle, for example, in a manner similar to that described above with respect to FIG. 2A. The method 600 can proceed to decision block 610, where it is determined if a next sample spot should be selected, for example, to deposit first precursor on a next spot on the substrate. If so, the method 600 can proceed to process block 612, where the next spot is selected, and the deposition of first precursor in process block 608 is repeated for the selected next spot.

If no further deposition of the first precursor is desired, the method 600 can proceed from decision block 610 to decision block 614, where it is determined if the deposited precursor should be subject to pre-sintering. For example, in some embodiments, after dispensing of one precursor on all desired spots of the substrate, the substrate can be subjected to thermal shock or at least to a thermal treatment at process block 616 prior to beginning dispensing of the next precursor. In some embodiments, such independent treatment of the precursors may help in mixing the elements of the deposited precursor with elements from subsequent precursor depositions. Otherwise, if pre-sintering is not desired, the method 600 can proceed from decision block 614 to decision block 616, where it is determined if additional precursors should be deposited. If so, the method 600 can proceed from decision block 618 to process block 620, where the next precursor is selected, and the deposition in process block 608 is repeated with the new precursor.

If no further deposition of any precursors is desired, the method 600 can proceed from decision block 618 to process block 622, where the deposited precursors are converted to multielement materials by subjecting the substrate to a thermal shock. In some embodiments, the subjecting of process block 622 can be performed using a heating device, for example, in a manner similar to that described above with respect to any of FIGS. 4A-4C. After process block 622, the method 600 can optionally proceed to process block 624, where individual electrodes (e.g., Au microdots) can be deposited atop the multielement materials, for example, in a configuration similar to that illustrated in FIG. 3D.

The method 600 can proceed to process block 626, where a first multielement material of the substrate is selected for screening. At process block 628, the selected multielement material can be testing, for example, with respect to an electrical property, a chemical property, or an optical property. In some embodiments, the testing of process block 628 can be performed using an evaluation device, for example, in a manner similar to that described above with respect to any of FIGS. 5A-5D. In some embodiments, the method 600 can proceed to process block 630, where the test results can optionally be compared against predetermined criteria, e.g., a minimum or ideal performance value for a particular application. Alternatively, in some embodiments, the comparison can be reserved in favor of simultaneous evaluation of results for multiple fabricated materials, for example, via data mining or machine learning.

The method 600 can proceed to decision block 632, where it is determined if a next material should be selected for testing. If so, the method 600 can proceed to process block 634, where the next material is selected, and the testing in process block 628 is repeated for the selected next material. Alternatively, in some embodiments where the screening is performed in parallel (e.g., in a manner similar to that illustrated in FIGS. 5B and/or 5D), the selection of process blocks 626, 634 and decision block 632 can be omitted.

If no further testing is desired, the method 600 can proceed from decision block 632 to process block 636, where a material composition for use in a predetermined application can be determined. In some embodiments, the determination of process block 636 can be selection of one of the tested material samples that exhibit the best performance with respect to one or more predetermined criteria for the particular application, for example, a material that exhibits a highest electrocatalytic activity of those tested. Alternatively or additionally, the determination of process block 636 can act as feedback for a subsequent performance of method 600, for example, by providing a material composition or range thereof to serve as the basis for a new combinatorial mapping.

FIG. 6B illustrates another exemplary method 640 for combinatorial synthesis and screening of multielement materials. The method 640 can initiate at process block 602, where a substrate can be provided, for example, in a manner similar to that described above with respect to FIG. 6A. The method 640 can proceed to process block 604, where sample spots with different intended material compositions can be mapped onto the substrate according to a combinatorial approach, for example, in a manner similar to that described above with respect to FIG. 6A. The method 640 can then proceed to process block 642, where precursors can be premixed in separate batches per the mapped material compositions. At process block 606, a first sample spot on the substrate can be selected, and at process block 644, a first premixed precursor can be deposited on the first sample spot according to the mapped material composition. In some embodiments, the premixing of process block 642 and/or the deposition of process block 644 can be performed in a manner similar to that described above with respect to FIG. 2B. After process block 642, performance of blocks 610, 612, and 622-636 may otherwise be the same as described above with respect to FIG. 6A.

FIG. 6C illustrates another exemplary method 650 for combinatorial synthesis and screening of multielement materials. The method 650 can initiate at process block 652, where a substrate can be provided, for example, in a manner similar to that described above with respect to FIG. 6A. Process block 652 can also include providing separate precursor supplies, for example, in a setup similar to that illustrated in FIG. 2C. The method 650 can proceed to process block 604, where sample spots with different intended material compositions can be mapped onto the substrate according to a combinatorial approach, for example, in a manner similar to that described above with respect to FIG. 6A. At process block 606, a first sample spot on the substrate can be selected, and at process block 654, amounts from each precursor supply can be dispensed according to the mapped material composition. In some embodiments, the deposition of process block 654 can be performed in a manner similar to that described above with respect to FIG. 2C. In some embodiments, the dispensing from the precursor supplies can occur simultaneously, e.g., with mixing from each supply occurring upstream of a nozzle (e.g., en route to deposition). Alternatively, in some embodiments, the dispensing from the precursor supplies can occur sequentially, e.g., with mixing occurring on the substrate and before the nozzle moves to the next spot. After process block 654, performance of blocks 610, 612, and 622-636 may otherwise be the same as described above with respect to FIG. 6A.

In FIGS. 6A-6C, although some of blocks 600-654 have been described as being performed once, in some embodiments, multiple repetitions of a particular process block may be employed before proceeding to the next decision block or process block. In addition, although blocks 600-654 have been separately illustrated and described, in some embodiments, process blocks may be combined and performed together (simultaneously or sequentially). Moreover, although FIGS. 6A-6C illustrate a particular order for blocks 600-654, embodiments of the disclosed subject matter are not limited thereto. Indeed, in certain embodiments, the blocks may occur in a different order than illustrated or simultaneously with other blocks.

### Computer Implementation

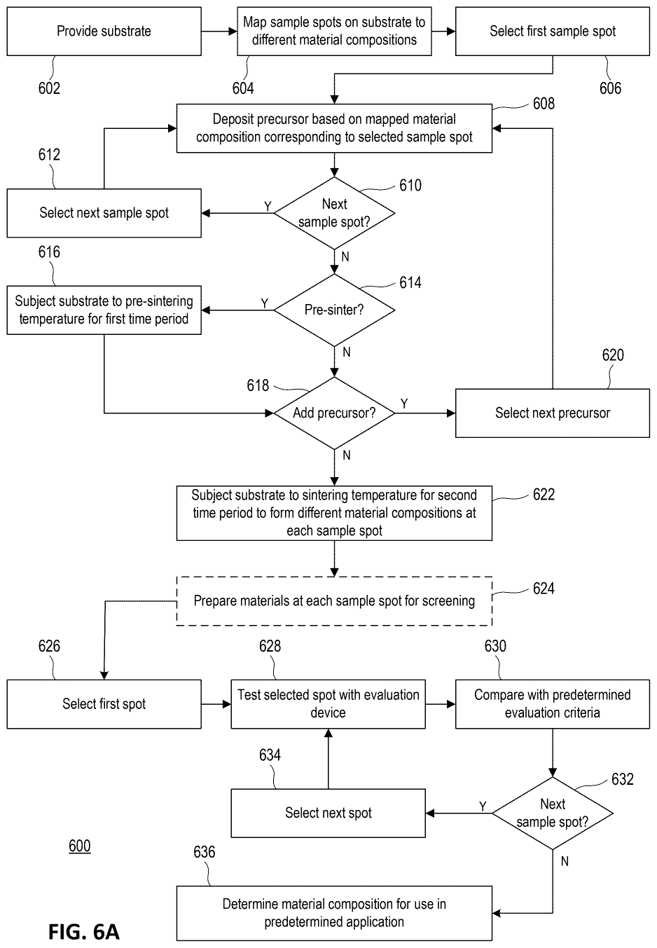

FIG. 7 depicts a generalized example of a suitable computing environment 731 in which the described innovations may be implemented, such as aspects of method 600, method 640, method 650, control system 118, and/or control system 148. The computing environment 731 is not intended to suggest any limitation as to scope of use or functionality, as the innovations may be implemented in diverse general-purpose or special-purpose computing systems. For example, the computing environment 731 can be any of a variety of computing devices (e.g., desktop computer, laptop computer, server computer, tablet computer, etc.).

With reference to FIG. 7, the computing environment 731 includes one or more processing units 735, 737 and memory 739, 741. In FIG. 7, this basic configuration 751 is included within a dashed line. The processing units 735, 737 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 7 shows a central processing unit 735 as well as a graphics processing unit or co-processing unit 737. The tangible memory 739, 741 may be volatile memory (e.g., registers, cache, RAM), non-volatile memory (e.g., ROM, EEPROM, flash memory, etc.), or some combination of the two, accessible by the processing unit(s). The memory 739, 741 stores software 733 implementing one or more innovations described herein, in the form of computer-executable instructions suitable for execution by the processing unit(s).

A computing system may have additional features. For example, the computing environment 731 includes storage 761, one or more input devices 771, one or more output devices 781, and one or more communication connections 791. An interconnection mechanism (not shown) such as a bus, controller, or network interconnects the components of the computing environment 731. Typically, operating system software (not shown) provides an operating environment for other software executing in the computing environment 731, and coordinates activities of the components of the computing environment 731.

The tangible storage 761 may be removable or non-removable, and includes magnetic disks, magnetic tapes or cassettes, CD-ROMs, DVDs, or any other medium which can be used to store information in a non-transitory way, and which can be accessed within the computing environment 731. The storage 761 can store instructions for the software 733 implementing one or more innovations described herein.

The input device(s) 771 may be a touch input device such as a keyboard, mouse, pen, or trackball, a voice input device, a scanning device, or another device that provides input to the computing environment 731. The output device(s) 771 may be a display, printer, speaker, CD-writer, or another device that provides output from computing environment 731.

The communication connection(s) 791 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Fabricated Examples and Experimental Results

Conventionally, vapor-phase depositions can create a large number of samples using composition gradient. However, vapor-phase deposition requires sophisticated and expensive equipment with a limited choice of materials and substrates. In contrast, the high-throughput synthesis disclosed herein involves two relatively simple steps: (1) combinatorial composition design using metal precursors by formulation in solution phases; and (2) uniform MMNC synthesis by rapid thermal shock of a precursor-loaded carbon support, which drives the rapid precursor decomposition and alloy formation.

High-throughput synthesis of multimetallic nanoclusters (MMNCs) was achieved by combinatorial composition formulation in the solution phase on a surface-treated carbon support, followed by a rapid thermal-shock treatment. These compositionally-different MMNCs (with similar particle size and structure) were rapidly screened using scanning droplet cell analysis for the electrochemical oxygen reduction reaction (ORR), enabling efficient identification of the two best-performing catalysts. The combination of such high-throughput approaches can establish a facile and reliable pipeline to significantly accelerate discovery of MMNCs as advanced catalytic materials.

In particular, a series of MMNCs were fabricated, ranging from ternary materials (e.g., PtPdRh) to octonary materials (e.g., PtPdRhRuIrFeCoNi), by adding one element at a time. Precursors for each of the different composition MMNCs were loaded on a carbon nanofiber (CNF) substrate. To form the substrate, electrospun polyacrylonitrile nanofibers were stabilized in air at 533 K (260° C.) for 6 hours, and then carbonized at 1173 K (900° C.) for 2 hours in argon to form untreated CNFs. The CNF films were then further thermally activated at 1023 K (750° C.) for 2 hours in a CO₂ atmosphere in order to create surface defects (e.g., a CO2-activated CNF (CA-CNF) substrate).

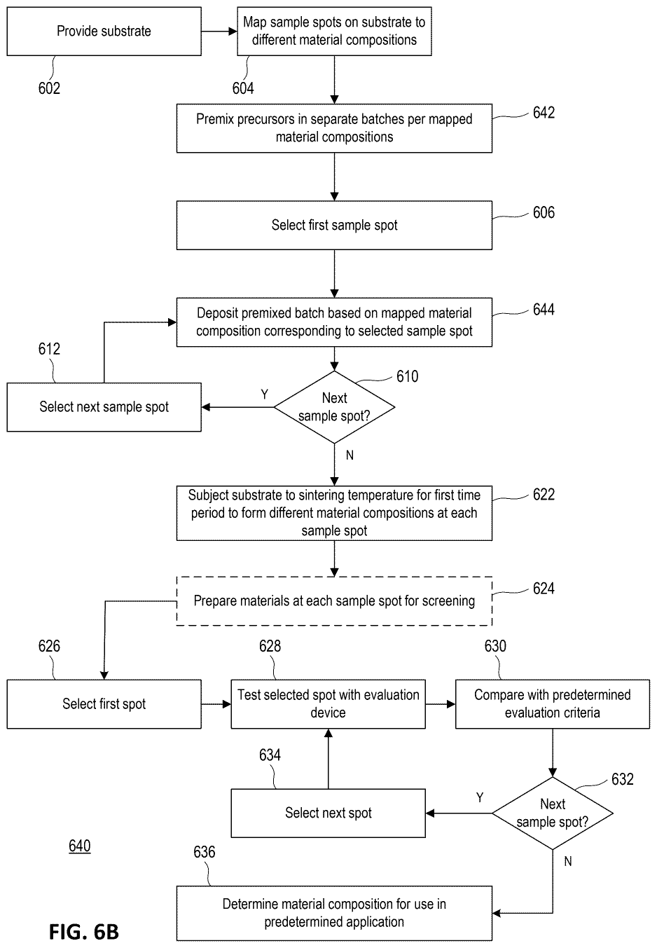

The individual metal salts or their hydrate forms were dissolved in ethanol at a concentration of 0.05 mol/L. Moreover, 10% (in volume) of 37% HCl was added to PdCl 2 solution to complete dissolve PdCl₂. The salt precursor solution was loaded onto the suspended CA-CNF film 804 via a print head 802 of a programmable 3D printer 800 (Fisnar F4200N), as shown in FIG. 8A, or manually using a pipette. The precursor loading was 5 umol/cm 2. The precursor salts were used at 1:1 molar ratios between each metallic element in the MMNC design. The printed precursor mixture showed a homogeneous and uniform precursor distribution on the carbon substrates, proved via energy dispersive spectroscopy (EDS) mapping. The initial homogeneity of the formulated precursors can ensure subsequent particle uniformity.

The precursor-loaded carbon supports were then subjected to high-temperature thermal shock by electrically Joule heating to ˜1650 K for a duration of ˜500 ms. The samples were electrically connected in series for batch thermal shocking, as shown in FIG. 8B, or heated individually. In either case, the shock heating induced the rapid decomposition of precursors and the formation of uniformly-dispersed nanoparticles. The surface defects on the carbon support can help to disperse the MMNCs and ensure their size uniformity among the compositionally-different samples, while the rapid thermal-shock treatment can yield single-phase structures due to high-temperature mixing and fast quenching. The thermal shock process was performed with the precursor-loaded CA-CNF film 804 in an argon-filled glovebox. For batch shock processes (thermally-shocking several samples at once), the electrical circuit design involved connecting copper electrodes in series and then thermally shocking all the samples (e.g., glowing regions at 806 in FIG. 8B) at one time. In order to achieve uniform temperature in these samples in series, the size of the samples was made as close to the same as possible.

Transmission electron microscopy (TEM) images show the ultra-small and uniform distribution of PtPdRh, PtPdRhRuIr, and PtPdRhRuIrFeCoNi MMNCs, thereby confirming their similar size and dispersity despite the compositional differences. High-resolution high-angle annular dark-field (HAADF) images of the three MMNCs further confirm the similar size distributions, i.e., particles sizes for the PtPdRh, PtPdRhRuIr, and PtPdRhRuIrFeCoNi MMNCs of 3.3 nm±0.8 nm, 3.4 nm±0.7 nm, and 3.7 nm±1 nm, respectively.

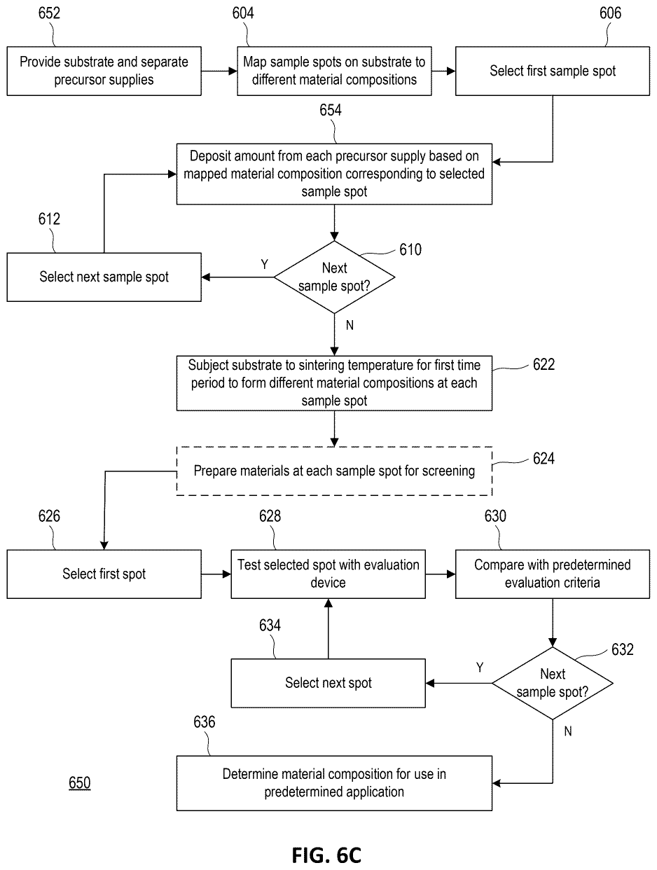

As shown in FIGS. 9A-9B, the sizes and particle dispersion densities of MMNCs synthesized by thermal shock method were compared with examples fabricated by conventional methods, in particular, advanced probe lithography (physical method) or macromolecular template techniques (chemical control). Since particles composed of more than five elements have not been synthesized by the conventional methods, ternary, quaternary, and quinary nanoparticles were selected for comparison. The ternary, quaternary, and quinary MMNCs synthesized by probe lithography exhibit a size distribution of 12.4±1.8 nm, 38.1±3.1 nm, and 30.0±4.7 nm, respectively, with a patterning density of 1/um 2 (e.g., 1×10⁻⁶/nm²) on a flat surface. While much smaller MMNCs (˜1.3±0.2 nm) can be synthesized using the macromolecular template method, the dispersion density is quite low (e.g., 1×10⁻³/nm²) and the composition of choice is also limited. In contrast, in the thermal shock synthesis on defective carbon supports, both the size and dispersal density remain similar for MMNCs with various compositions, which can be useful in comparative studies between MMNCs of different compositions.

For conventional synthesis methods, incorporating more elements typically results in heterogeneous structures due to the immiscibility among different elements. In contrast, use of the disclosed thermal shock method can overcome immiscibility by creating liquid metal alloy states at high temperature, followed by rapid quenching to largely maintain the alloy mixing. In addition, the multielement materials could help drive the alloy formation by increasing entropy (ΔGₘᵢₓ↓=ΔHₘᵢₓ−T*ΔSₘᵢₓ↓), which provides kinetic constraints (e.g., severe lattice distortion and sluggish diffusion) such that alloy structures are discouraged from phase separation. The detailed structures of thermal-shock-fabricated MMNCs were fabricated using HAADF and EDS mapping. Low-magnification HAADF and EDS maps confirmed the ultrafine size and high-density dispersion of the nanoclusters, with each element roughly distributed throughout the fiber support without obvious elemental segregation. High-resolution HAADF and EDS images of the ternary, quinary, and octonary samples show particles of ˜3-4 nm in size, with each element being uniformly distributed within each nanocluster without clear phase separation or elemental segregation, indicating a solid-solution structure. Note that the final compositions in the MMNCs may be differ slightly from the designed/expected composition, for example, due to differences in metal vapor pressures at high temperatures. The thermal shock method enables alloying at high temperatures while limiting the duration of heating duration, thereby reducing metal losses.

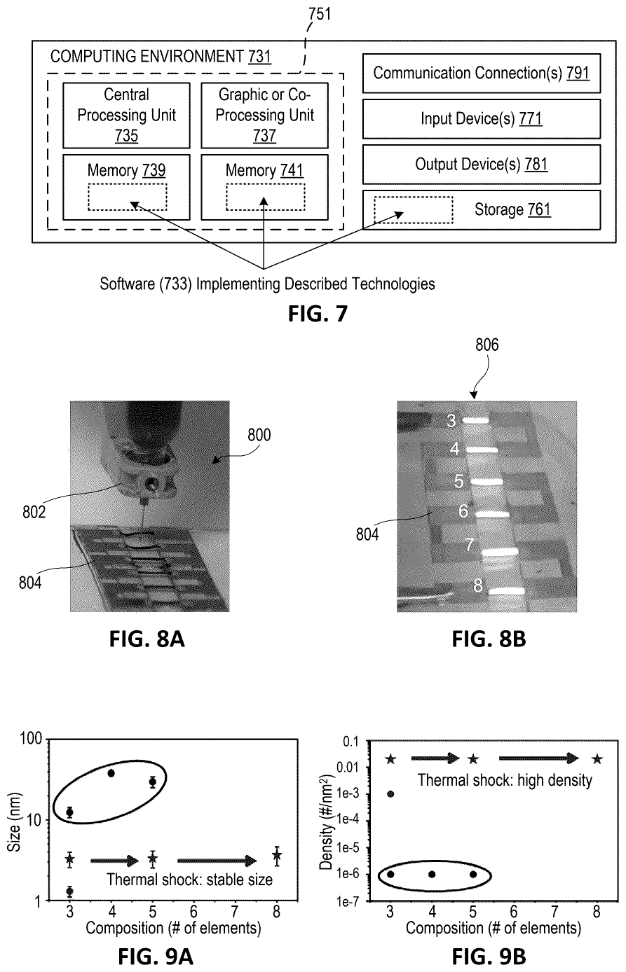

Macroscopically, powder X-ray diffraction (XRD) profiles illustrate an overall face-centered-cubic (FCC) structure for ternary, quinary, and octonary MMNCs using the Rietveld refinement with a fitted lattice constant of 3.87, 3.82, and 3.76 Å, respectively, as shown in FIG. 10A. No obvious secondary phases were detected. The decreasing lattice constant can be due to the increasing ratio of non-noble metals (e.g., Fe, Co, Ni) with a smaller size and lattice constant. In addition, synchrotron XRD was performed to detect the fine structure and possible impurity phases in the MMNCs using a much smaller wavelength (λ=0.2113 Å). As shown in FIG. 10B, all the major peaks can be indexed according to the FCC structure and a fitted lattice constant of 3.87 Å using Rietveld refinement with a reasonably good fit. Namely, the PtPdRh MMNCs still exhibit a largely single FCC phase under synchrotron detection, further confirming the single-phase alloy structure. The diffraction data was converted using q-unit, where q=(4πV2)sinθ so that the data are comparable in the q-unit regardless of the difference in X-ray energy. The solid-solution formation and alloy structural consistency of these MMNCs can be helpful for comparative catalytic studies.

From a high-throughput perspective, the overall MMNC synthesis protocol involves only printing precursor salts and rapid thermal shock, which are all physical processes that can be easily scaled up. Different metal salt solutions with desired recipes were mixed in the liquid phase. In particular, the combinatorial compositions were designed and formulated in the solution phase using individual precursor solutions with a concentration of 0.05 mol/L. The mixture solutions were then deposited on respective CA-CNF disks (˜0.3-inch diameter) with a loading of 100 μL/cm² (i.e., ˜5 μmol/cm²). These CA-CNF disks were then attached in a pattern (e.g., regular layout) onto a common surface of a copper plate (e.g., copper-foil wrapped silicon wafer) via conductive silver paste. Then, rapid radiative heating (non-direct contact) was used for the MMNC synthesis by positioning a high-temperature heating source above a subset of the samples (e.g., spaced by about ˜0.5 cm) and subjected to repeated thermal shock (e.g., heating to 2000 K (1727° C.) for a duration of ˜0.5 s, for 3 times). Then the heating element was moved to the next subset of samples until all the samples on the substrate had been heated. A piece of graphitic carbon paper was used as the radiative heating source driven by Joule-heating in an Ar-filled glovebox.

Using this method, a plate containing a library of 88 samples, including (1) MMNCs in the PtPdRhRuIrFeCoNi compositional space for ORR, and (2) MMNCs in the IrRuAuPdMnFeCoNi space for oxygen evolution reaction (OER), with each composition having 2 samples for cross-validation. The single-phase structure and uniform size distributions of selected MMNCs were also verified. The PtPdRhRuIrFeCoNi compositional space was synthesized and screened using scanning droplet cell electrochemistry, with two promising catalysts quickly identified and further verified in a rotating disk setup. High-throughput electrochemistry was performed to rapidly screen for promising MMNC catalysts. Scanning droplet cell analysis (e.g., as shown in FIG. 5A) was used as a high-throughput electrochemical screening method for the rapid identification of active electrocatalysts. It integrates an ordinary three-electrode setup into a single tip (e.g., 0.785 mm² area) for fast, continuous, and potentially automated screening. The copper plate can act as the common current collector from working electrodes during the fast screening. The ORR was used as a model reaction to illustrate one potential implementation of the rapid catalysts screening process, although other screening processes are also contemplated. ORR is a common cathode reaction to enable fuel cell technologies, yet it is kinetically sluggish with a high overpotential owing to the four-electron transfer process. Discovering high-performance, low-cost, and robust catalysts would therefore be useful to improve ORR and fuel cell operation efficiency.

The electrochemical tests were performed at room temperature. After moving to a new sample location, the first 30 seconds was used to stabilize the contact between the droplet volume and the selected sample. The electrochemical tests included two 20 mV/s cyclic voltammetry sweeps followed by one 5 m V/s cyclic voltammetry sweep between 1.1 V and 0.45 V versus reversible hydrogen electrode (RHE). A capillary Ag/AgCl electrode reference electrode was flushed with fresh saturated KCI solution every 30 minutes to avoid possible contamination. Because the magnitude of the measured current was around 10⁻⁴ A, the ohm drop was neglectable. However, the IrRu-based MMNCs samples for OER were found to have apparent corrosion current at high potential, which can obscure the performance and cause uncertainty. Therefore, the following discussion focuses on the PtPd-based compositions for ORR.

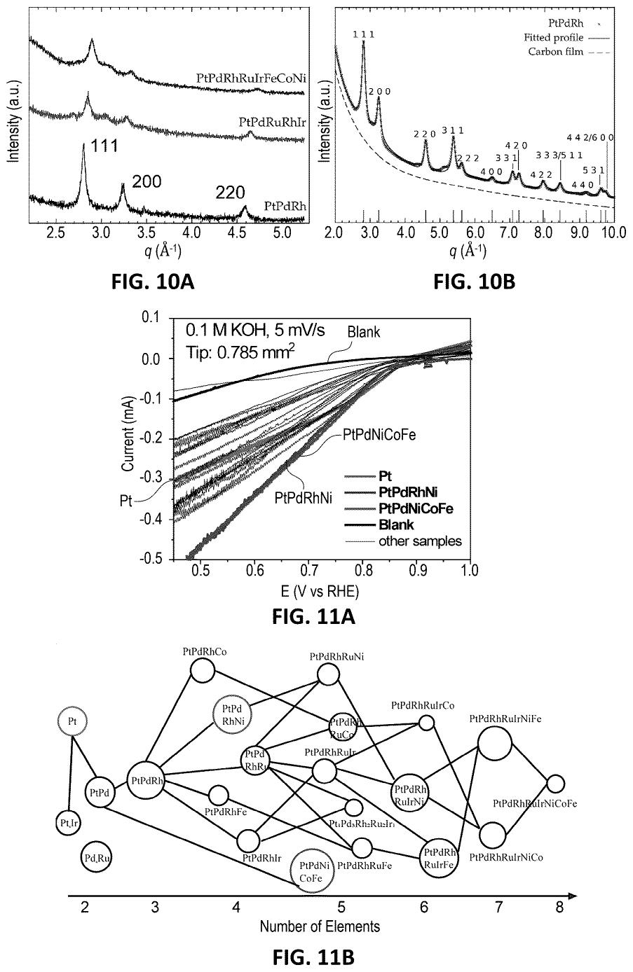

As shown in FIG. 11A, linear sweep voltammetry (from 1.1 V to 0.45 V) and cyclic voltammetry for different MMNC samples were performed in 0.1 M KOH at a scan rate of 5 mV/s to compare their activity and stability. The blank sample showed very weak activity towards ORR, while the control Pt sample exhibited a good ORR catalytic activity, achieving −3×10⁻⁴ A at 0.45 V versus RHE. For the MMNC samples, while all share a low onset potential similar to the Pt control, PtPdRhNi and PtPdFeCoNi showed a much larger current at a given potential than others, indicating higher activity. For all MMNC samples, the current continues to increase as the potential decreases without showing a limiting current plateau, due to relatively excessive oxygen being fed to the catalyst such that the reaction was not limited by oxygen mass transfer.

FIG. 11B summarizes the specific current at 0.45 V of different samples and reconstructed into a neural network diagram, where the size of the circles represents the magnitude of the sample's specific current at 0.45 V and the lines indicate connections between compositions. Although a relationship between composition and performance is not readily apparent upon initial review of FIG. 11B, the testing results can be harnessed via data mining and/or machine learning processes to uncover the hidden relationship of elemental compositions to the catalytic performances, which processes can be used to guide subsequent MMNC material design to accelerate catalyst discovery. To gain further insights into the two best-performing catalysts, macroscale and microscale techniques were used for structural characterization. As shown in FIG. 11C, the synchrotron XRD profiles of these two MMNCs (PtPdRhNi and PtPdFeCoNi) exhibit a single-phase FCC structure under synchrotron detection (λ=0.2113 Å), with a fitted lattice constant of 3.78 and 3.73 Å, respectively, which are very similar to the powder diffraction data. The size distribution of the MMNCs was also verified, as well as their alloy structure by microscopic evaluation. The size remains small and uniformly distributed, while each element is distributed homogeneously throughout the nanoparticles, confirming the alloy structure at nanoparticle level. The synchrotron XRD and TEM data verified the small size and single-phase alloy structure of the MMNCs synthesized using the high-throughput thermal shock method.

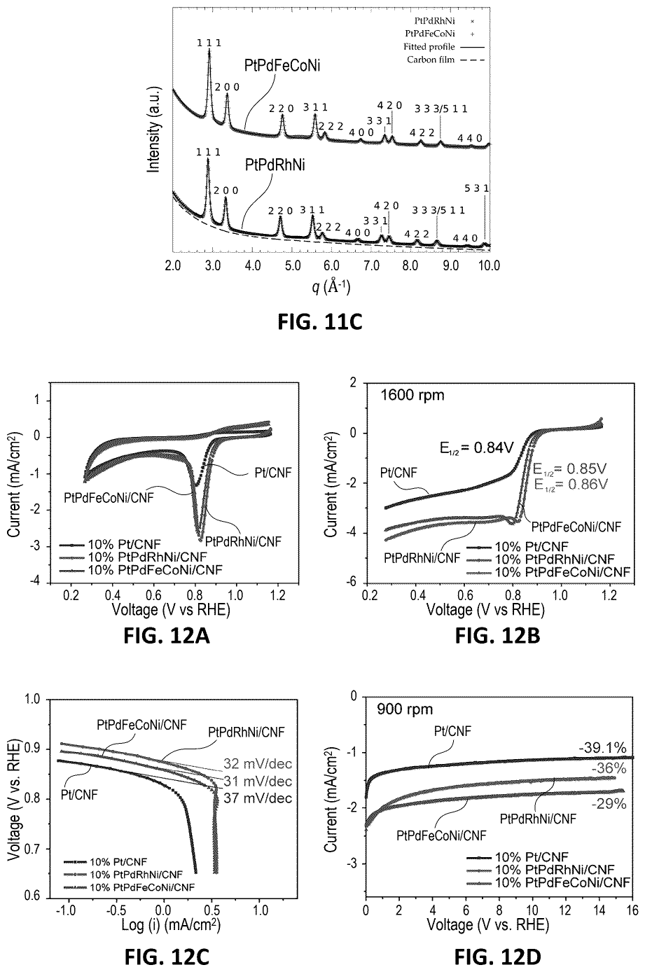

To verify the high performance of the two optimized catalysts (PtPdRhNi and PtPdFeCoNi), electrochemical analysis was performed using a rotating disk electrode (RDE) setup, in particular a Pine Bipotentiostat RDE4 with a glassy carbon (GC) rotating disk electrode (RDE, 0.196 cm²) and a rotating ring-disk electrode (RRDE, 0.247 cm², collection coefficient 0.37). The two MMNCs (PtPdRhNi and PtPdFeCoNi) and the Pt control were synthesized on CA-CNF with a loading of ˜10 wt % using the thermal shock synthesis approach. These samples were then prepared into inks for the measurement in 1.0 M KOH at room temperature (22±1° C.). FIG. 12A showcases the cyclic voltammograms of the PtPdRhNi and PtPdFeCoNi MMNCs and a Pt control sample (10 wt % loading) in an oxygen-saturated electrolyte (1 M KOH). A sharp peak evolved at ˜0.85 V for all three samples, which corresponds to the reduction of oxygen. The peak positions of the MMNC catalysts are slightly positive compared with that of Pt as a control, indicating their lower overpotentials and therefore better catalytic activity.

In addition, both MMNC catalysts exhibit increased peak current densities by about a factor of two as compared to that of Pt. In FIG. 12B, linear sweep voltammograms of the MMNC catalysts display flat limiting current densities with much higher values and slightly more positive half-wave potentials compared to that of Pt, further confirming the better activity of these MMNCs compared with the Pt control sample. Through the Tafel analysis of FIG. 12C, slightly smaller Tafel slopes for the MMNCs (32 and 31 mV/dec) were measured as compared with Pt (37 mV/dec), indicating a similar reaction mechanism in ORR. Rotating ring-disk measurement were performed with a small ring-current, and the overall ORR electron number was confirmed to be 3.9˜4.0 toward a total oxygen reduction. In addition, the long-term stability of the as-prepared catalysts was tested by chronoamperometry at 0.6 V (versus RHE), as shown in FIG. 12D. The current density of PtPdRhNi decreased by 36% after 15 hours of operation. Slightly better activity retention (e.g., decreased by 29% after 15 hours of operation) was measured for PtPdFeCoNi. In contrast, the current density of Pt decreased by 39.1% after the same time period, during which most of the activity loss occurred within the first hour.

### Conclusion

Any of the features illustrated or described herein, for example, with respect to FIGS. 1A-12D, can be combined with any other feature illustrated or described herein, for example, with respect to FIGS. 1A-12D to provide systems, devices, structures, methods, and embodiments not otherwise illustrated or specifically described herein. For example, any of the substrate configurations of FIGS. 3A-3F can be used in the embodiments of FIGS. 1A-2C and 4A-6C. Other combinations and variations are also possible according to one or more contemplated embodiments. Indeed, all features described herein are independent of one another and, except where structurally impossible, can be used in combination with any other feature described herein.

In view of the many possible embodiments to which the principles of the disclosed technology may be applied, it should be recognized that the illustrated embodiments are only examples and should not be taken as limiting the scope of the disclosed technology. Rather, the scope is defined by the following claims. Applicant therefore claims all that comes within the scope and spirit of these claims.

1. A method comprising:
(a) depositing one or more first precursors on a first portion of a substrate;
(b) depositing one or more second precursors on a second portion of the substrate, the second portion being spaced from the first portion; and
(c) subjecting each of the first and second portions of the substrate to a first temperature for a first time period so as to convert the deposited one or more first precursors into a first material and to convert the deposited one or more second precursors into a second material,
wherein the first material has a different composition than the second material,
the first temperature is greater than or equal to about 500° C., and
a duration of the first time period is less than about 60 seconds.

2. The method of claim 1, further comprising:
(d) testing each of the first and second materials with respect to an electrical property, a chemical property, an optical property, or any combination thereof.

3. The method of claim 2, wherein the testing of (d) comprises measuring an electrochemical impedance spectroscopy (EIS) spectrum for each of the first and second materials, measuring an ionic conductivity for each of the first and second materials, measuring fluorescence of each of the first and second materials, or any combination of the foregoing.

4. The method of claim 2, further comprising:
(e) determining a composition of a material for use in a predetermined application based at least in part on results of the testing of (d).

5. The method of claim 4, wherein the determining of (e) comprises selecting one of the first and second materials for use in the predetermined application.

6. The method of claim 4, wherein the predetermined application comprises use as (i) a catalyst, (ii) a plasmonic nanoparticle, (iii) an energy storage device, (iv) an optoelectronic device, (v) a solid-state electrolyte, (vi) an ion conductive membrane, (vii) a fluorescent material, (viii) a component of any of (i)-(vii), or any combination of (i)-(viii).

7. The method of claim 1, wherein the first temperature is in a range of 1000° C. to 3000° C., inclusive.

8. The method of claim 1, wherein a duration of the first time period is in a range of 0.5 seconds to 30 seconds, inclusive.

9. The method of claim 1, further comprising, prior to (a) and (b):
(g1) depositing one or more third precursors on the first portion of the substrate;
(g2) depositing one or more fourth precursors on the second portion of the substrate; and
(g3) subjecting each of the first and second portions of the substrate to a second temperature for a second time period so to convert the deposited one or more third precursors into a third material and to convert the deposited one or more second precursors into a fourth material,
wherein the depositing of (a) is on the third material and the depositing of (b) is on the fourth material, and
the subjecting of (c) converts the one or more first precursors and the third material into the first material and converts the one or more second precursors and the fourth material into the first material.

10. The method of claim 1, wherein the subjecting of (c) is effective to sinter the one or more first precursors together to form the first material, and to sinter the one or more second precursors together to form the second material.

11. The method of claim 1, wherein:
the depositing of (a) comprises depositing the one or more first precursors in a vapor phase, in a salt solution, or as a microparticle;
the depositing of (b) comprises depositing the one or more second precursors in a vapor phase, in a salt or oxide solution, or as a microparticle; or
both of the above.

12. The method of claim 1, wherein the first material is formed as a nanocluster or nanoparticle, the second material is formed as a nanocluster or nanoparticle, or each of the first and second materials is formed as a respective nanocluster or nanoparticle.

13. The method of claim 1, wherein:
the one or more first precursors comprises at least three elements in a first compositional ratio; and
the one or more second precursors comprise the same elements as the one or more first precursors in a second compositional ration different from the first compositional ratio.

14. The method of claim 1, wherein the subjecting of (c) comprises:
subjecting the first portion of the substrate to the first temperature for the first time period duration, and then subjecting the second portion of the substrate to the first temperature for the first time period duration; or
simultaneously subjecting the first and second portions of the substrate to the first temperature for the first time period duration.

15. A system comprising:
a dispensing device having a nozzle facing a surface of a substrate and constructed to deposit precursors onto the substrate, at least one of the nozzle and the substrate being movable with respect to the other;
a heating device constructed to generate a first temperature of at least 500° C.; and
a control system operatively coupled to the dispensing device and the heating device, the control system comprising one or more processors and computer readable storage media storing instructions that, when executed by the one or more processors, cause the control system to:
control the dispensing device to position the nozzle with respect to a first portion of the substrate;
deposit, via the nozzle, one or more first precursors on the first portion;
control the dispensing device to position the nozzle with respect to a second portion of the substrate, the second portion being spaced from the first portion;
deposit, via the nozzle, one or more second precursors on the second portion; and
subject, via the heating device, each of the first and second portions of the substrate to the first temperature for a first time period so to convert the deposited one or more first precursors into a first material and to convert the deposited one or more second precursors into a second material,
wherein the first material has a different composition than the second material, and a duration of the first time period is less than 60 seconds.

16. The system of claim 15, wherein the heating device comprises a Joule heating element, a microwave heating device, a laser, or any combination of the foregoing.

17. The system of claim 15, wherein the dispensing device comprises an ink jet printer head, an additive manufacturing printer head, a pipette, or any combination of the foregoing.

18. The system of claim 15, wherein:
the dispensing device comprises at least three reservoirs coupled to the nozzle, each reservoir containing a different element in solution; and
the computer readable storage media stores additional instructions that, when executed by the one or more processors, cause the control system to:
mix, via the dispensing device, the elements in solution from the at least three reservoirs in a first compositional ratio to provide the one or more first precursors for deposition; and
mix, via the dispensing device, the elements in solution from the at least three reservoirs in a second compositional ratio, different from the first compositional ratio, to provide the one or more second precursors for deposition.

19. The system of claim 15, further comprising:
an evaluation device constructed to measure an electrical property, a chemical property, an optical property, or any combination thereof of a material,
wherein the computer readable storage media stores additional instructions that, when executed by the one or more processors, cause the control system to test, via the evaluation device, each of the first and second materials.

20. The system of claim 19, wherein the computer readable storage media stores additional instructions that, when executed by the one or more processors, cause the control system to determine a composition of a material for use in a predetermined application based at least in part on results of the testing.
